(19) United States
(12) Patent Application Publication
(10) Pub. No.: US 2024/0161141 A1
(43) Pub. Date: May 16, 2024

(54) SYSTEMS AND METHODS FOR SALES PLANNING, TRAINING AND ACTION RECOMMENDATIONS

(71) Applicant: SalesMentor.ai, Inc., Short Hills, NJ (US)

(72) Inventors: Andrew Ian Schein, Sunnyvale, CA (US); Andrew Todd Flesch, Short Hills, NJ (US)

(73) Assignee: SalesMentor.ai, Inc., Short Hills, NJ (US)

(21) Appl. No.: 17/988,219

(22) Filed: Nov. 16, 2022

(51) Int. Cl. G06Q 30/02; G06N 7/00

(52) U.S. Cl. CPC G06Q 30/0211; G06N 7/005

(57) ABSTRACT

A sales system includes workflows defined for a sales opportunity with one or more stages in each of the workflows. Among the workflows, workflows for budget, interest, time, and human notions of deal progress may provide a dimensional view of deal progress and intervention strategy. The sales system determines recommended actions to progress the sales opportunity in response to a state of the sales opportunity in the one or more stages. The sales system further determines a deal score, probability of success, or value based on progress within the workflows and system variables. The behaviour of the recommendation system is determined by configured rules that specify how to simulate scenarios, as in a Markov decision process setting. An artificial intelligence component infers the optimal action recommendations from the simulation. A sales representative may track their progress in closing their deal through a deal score, as in a game.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

A great challenge of building and managing a sales team is the turnover and inexperience of the workforce. Organizations use a suite of sales management tools such as SALESFORCE® software and CLARI® software to help manage their sales teams. For training, organizations rely on classes and other materials that teach sales methodologies, including MEDDIC® seminars and MEDDPICC® training materials. Despite these existing mechanisms, experienced sales managers find the activity of inexperienced sales representatives sub-optimal. Many sales representatives lack the experience needed to evolve their sales activity into completed deals. In addition, due to this same inexperience, sales representatives are unable to assess the progress of a deal or the likelihood of success of a deal.

Even experienced sales representatives have difficulties when transitioning to new products or companies. For example, sales representatives with experience working at incumbent vendors have trouble selling new disruptive products at a start-up company, while sales representatives with experience working at start-up companies have analogous challenges at an organization with an incumbent status for numerous customers.

Existing sales management systems focus on capturing the mechanics of the interactions: what meeting happened, who was there, etc. Such systems help managers track sales activity and provide a venue for notes, but do not provide training or provide recommendations for next actions, e.g., based on a sales theory model. Growth of start-ups that disrupt competitors requires different sales software and workflow to produce change in a end user to replace an incumbent.

The default sales methodology, workflow, and software platforms focus on solving rational challenges with rational factors, i.e., does it save the organization money, provide value, etc. In practice, an organization may only introduce a new vendor and/or switch vendors or coexist two or more vendors when both rational factors and non-utility, irrational factors are considered. These non-utility, irrational factors may drive the decision in a disruptive sale as much as rational factors. Sales personnel do not have a software mentoring system or action recommendation system that considers both the rational and irrational components of an end user's decision-making process when determining the best course of action. These irrational factors include, e.g., value to the end user, does the end user trust you personally, does the end user trust the vendor, does the sales personnel have a good relationship with the end user, personal gain of an end user, resistance to change of the end user, politics of the end user, etc.

Sales personnel currently do not have a software resource to help access, focus on, or address these irrational factors in driving a disruptive sale. Existing sales products assume that the sales rep is responsible for understanding and processing the intangible/irrational factors in decision making. Junior sales representatives require guidance to apply these concepts correctly, and senior sales representatives require feedback on whether they have pursued all the intangible details potentially impacting their probability of success. Sales personnel do not have software with workflows that determines whether a sales opportunity is qualified and/or determines the probability that the sale can be completed using rational and irrational factors. The probability of a sale is often lower than the sales personnel reports in existing software because such factors are not input or considered by such current software applications. Sales personnel are not proactively and reactively guided toward solutions to overcome these objections. Likewise, incumbent sales need software to protect from “disruptors”.

Current software applications determine decision making ability based only on organizational charts, without consideration of intangible factors, such as the credibility of a decision maker or “champion”. Modern corporate organizational charts need to be refined by credibility and past successful projects as opposed to relative “power” in the organization. Existing and legacy sales and CRM and SAAS software provide lead generation, contact management, territory, and account management but do not provide dynamic sales analysis or recommendations from the point of initial contact to final decision. Other solutions focus on gathering utility or rational only data around why the particular disruptor's technology is better than the incumbents but doesn't look at irrational, behavioural, political, historical, personal, and other irrational based decision-making criteria or factors. Existing tools do not include measures of the progressiveness of the decision makers and company culture (the tendency to adopt new technologies) when assessing the likelihood of deal completion.

Existing sales systems guide sales representatives through workflows consisting of static scripts and checklists. Those systems do not decompose progress in selling into separate intercommunicating dimensions such as budget, motivating interest, time, and personal dynamics. Existing systems do not capture these dimensions in workflows each with their own stages. Current workflow systems do not represent states as settings of feature values, and consequently do not alter their recommendations based on nuanced circumstances including feature interactions spanning more than one workflow.

Finally, current software applications are focused on targeting to find opportunities, listing the details of a sales opportunity, managing a territory or group of accounts, and generally focused on only inputting data but not on producing knowledge and recommendations on next steps proactively and dynamically to gain entrance into an account and build credibility to disrupt an incumbent in a company.

Thus, there is a need for an improved sales opportunity management system that provides sales analysis and tracking as well as training and advice to identify and recommend a set of actions according to a customizable theory of sales.

### BRIEF SUMMARY OF THE INVENTION

Briefly stated, in one aspect of the present invention, disclosed is a sales system, including at least one memory device and at least one processing circuit, wherein the processing circuit is operatively coupled to the at least one memory device and wherein the at least one memory device stores instructions that, when executed by the at least one processing circuit, cause the sales system to determine a state of a sales opportunity from a plurality of predefined states; determine a recommended action using the state of the sales opportunity, wherein the recommended action is one of a plurality of predefined actions; and generate a graphical user interface (GUI) for display including the recommended action.

Briefly stated, in another aspect of the present invention, disclosed is a sales system, including at least one memory device and at least one processing circuit, wherein the processing circuit is operatively coupled to the at least one memory device and wherein the at least one memory device stores instructions that, when executed by the at least one processing circuit, cause the sales system to determine a current state of a sales opportunity from a plurality of predefined states; determine a probability of success of the sales opportunity associated with the current state; determine an expected deal value using the probability of success and an offering value; and generate a graphical user interface (GUI) for display including the expected deal value.

Briefly stated, in another aspect of the present invention, disclosed is a sales system, including at least one memory device and at least one processing circuit, wherein the processing circuit is operatively coupled to the at least one memory device and wherein the at least one memory device stores instructions that, when executed by the at least one processing circuit, cause the sales system to generate at least one stage for at least one workflow of a sales opportunity, wherein the at least one stages includes a plurality of variables; determine whether a stage satisfaction rule is satisfied using a set of values for the plurality of variables; when the stage satisfaction rule is satisfied, generate an indication of completion of the at least one stage; and when the stage satisfaction rule is not satisfied, determine a level of completion of the at least one stage using the set of values for the plurality of variables.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 illustrates an exemplary computing system environment for performing the methods described herein.

FIG. 2 illustrates an exemplary embodiment of the sales system interworking with one or more other software systems in accordance with one exemplary embodiment of the present invention.

FIG. 3 illustrates an exemplary embodiment of one or more application subsystems of the sales system in accordance with one exemplary embodiment of the present invention.

FIG. 4 illustrates an exemplary embodiment of a deal progression subsystem of the sales system in accordance with one exemplary embodiment of the present invention.

FIG. 5 illustrates an exemplary embodiment of a Budget Workflow of the sales system 100 in accordance with one exemplary embodiment of the present invention.

FIG. 6 illustrates an exemplary embodiment of an Interest Workflow of the sales system in accordance with one exemplary embodiment of the present invention.

FIG. 7 illustrates an exemplary embodiment of the Time Workflow of the sales system in accordance with one exemplary embodiment of the present invention.

FIG. 8 illustrates an exemplary embodiment of the Human Workflow of the sales system in accordance with one exemplary embodiment of the present invention.

FIG. 9 illustrates a method of processing a plurality of variables in a stage in accordance with one exemplary embodiment of the present invention.

FIG. 10A illustrates a method for stage completion in accordance with one exemplary embodiment of the present invention.

FIG. 10B illustrates a method for determination of whether the stage satisfaction rules are satisfied in accordance with one exemplary embodiment of the present invention.

FIG. 10C illustrates another method for determination of whether the stage satisfaction rules are satisfied in accordance with another exemplary embodiment of the present invention.

FIG. 10D illustrates another method for determination of whether the stage satisfaction rules are satisfied in accordance with another exemplary embodiment of the present invention.

FIG. 11 illustrates a method for determining a completion level of a workflow in accordance with one exemplary embodiment of the present invention.

FIG. 12 illustrates an exemplary embodiment of the action recommendation sub-system of the sales system in accordance with one exemplary embodiment of the present invention.

FIG. 13 illustrates an exemplary Markov Decision Process (MDP) representation of a stage for action recommendation in accordance with one exemplary embodiment of the present invention.

FIG. 14 illustrates an exemplary MDP representation of another stage for action recommendation in accordance with one exemplary embodiment of the present invention.

FIG. 15A illustrates a method for determining an action recommendation in accordance with one exemplary embodiment of the present invention.

FIG. 15B illustrates a method for determining an action recommendation in more detail in accordance with one exemplary embodiment of the present invention.

FIG. 16 illustrates an exemplary embodiment of the deal scoring subsystem and the deal value subsystem of the sales system in accordance with one exemplary embodiment of the present invention.

FIG. 17 illustrates a method for determining a deal score in accordance with one exemplary embodiment of the present invention.

FIG. 18A illustrates a method for determining an overall expected deal value in accordance with one exemplary embodiment of the present invention.

FIG. 18B illustrates a method for a probability of success of a sales opportunity at a current state in accordance with one exemplary embodiment of the present invention.

FIG. 19 illustrates an exemplary embodiment of the training subsystem of the sales system in accordance with one exemplary embodiment of the present invention.

FIG. 20 illustrates a method for providing training materials in the sales system in accordance with one exemplary embodiment of the present invention.

FIG. 21 illustrates a method of operation of the sales system according to one exemplary embodiment of the present invention.

FIG. 22 illustrates a graphical user interface (GUI) of a sales opportunity in the sales system according to one exemplary embodiment of the present invention

FIG. 23 illustrates a GUI of the Time Workflow in the sales system according to one exemplary embodiment of the present invention.

FIG. 24 illustrates a GUI of a stage of the Time Workflow in the sales system according to one exemplary embodiment of the present invention.

FIG. 25 illustrates another GUI of the time inhibiting variables stage of the time workflow in the sales system 100 according to one exemplary embodiment of the present invention.

FIG. 26 illustrates an updated GUI of the sales opportunity of the sales system according to one exemplary embodiment of the present invention.

### DETAILED DESCRIPTION OF THE INVENTION

The subject application references certain processes which are presented as a series of ordered steps. The steps described with respect to these processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

A sales system stores a combination of data inputs of utility and non-utility information in combination with an aggregation engine that receives pertinent information from third party databases. The sales system may aggregate data from such third-party database systems, including CRM, lead generation, account and territory management, and ERP type systems. Using these combined inputs, the sales system analyses the data using a customizable sales model with a set of one or more dimensions. For example, the set of dimensions may include budget, motivating interest, time, human motivation, or interpersonal connection. The one or more dimensions specify a plurality of performance steps or needed data for completion. Based on the completed performance steps and data, the system uses a dynamic artificial intelligence (AI) or neural network process and makes recommendations on next actions to the sales personnel. The recommendations include obtaining certain additional data or performing specific actions to further the sales process. A training module may provide information on approaches or strategies to explain the recommendations and the sales process. The training module may assist with strategies for a disruptor sale or provide strategies for an incumbent to defend against disruptor competition. The system includes rules for navigating irrational and rational components of selling, selling to progressive and conservatives end users, and understanding how these factors determine the likelihood of deal completion.

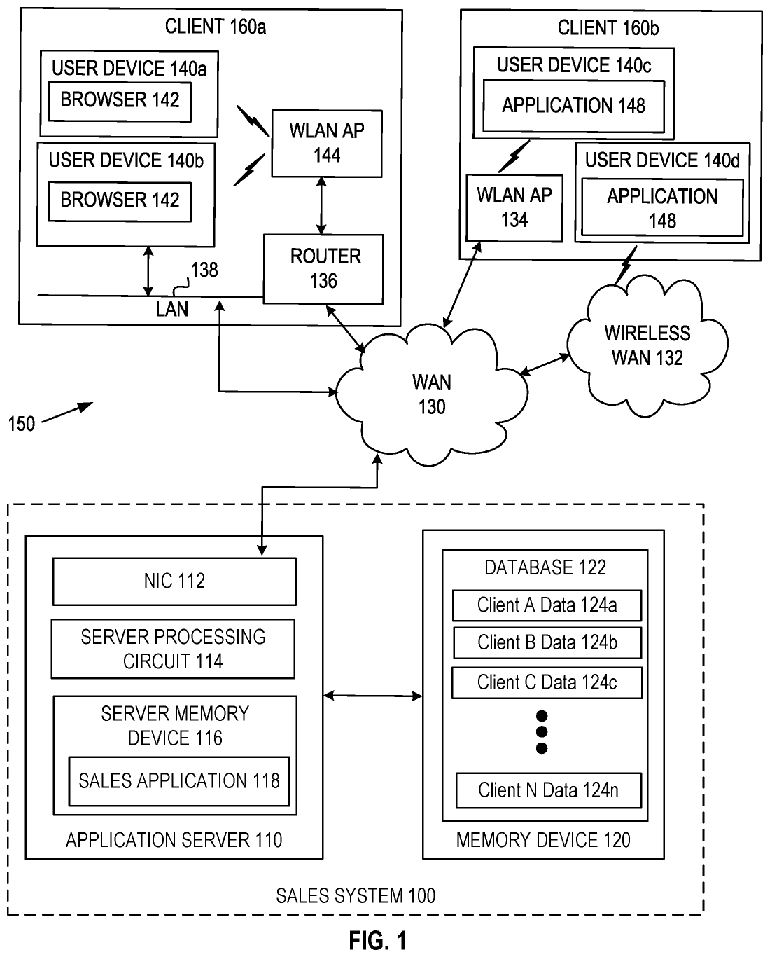

Referring now to FIG. 1, it illustrates an exemplary computing system environment 150 for performing the methods described herein. The sales system 100 may include at least one application web server 110 configured to provide the sales system 100 as a “Software as a Service” or SaaS system that allows access to the sales system 100 online by the one or more user devices 140a-b. The user devices 140 may include any processing device, such as a smartphone, laptop, desktop, smart tablet, smart watch, etc. The user devices 140 may also include user interface devices, such as keyboard, mouse, pen, voice input device, touch input device, a display, speakers, printer, etc.

In some embodiments of the present invention, the clients 160a-b may access exemplary sales system 100 using any web-enabled device equipped with a web browser. For example, the user devices 140a-b are equipped with one or more Web browsers 142 to allow them to interact with one or more servers and/or databases via a Hypertext Transfer Protocol (“HTTP”). HTTP functions as a request-response protocol in client-server computing. For example, a web browser operating on computing device 2402 may execute a client application that allows it to interact with applications executed by the one or more servers. The client application submits HTTP request messages to the one or more servers. The corresponding servers, which provide resources such as HTML files and other data or content or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

In another embodiment, a user application 148 may be downloaded from the application web server 110 and installed on the user devices 140c-d. The user application 148 may communicate with the application web server 110 for updates, user data, or certain processes. For example, a standard client server technology architecture may be implemented, which allows users of sales system 100 to access information stored in the databases via custom user interfaces. Communication between software components and sub-systems are achieved by a combination of direct function calls, publish, and subscribe mechanisms, stored procedures, and direct SQL queries, however, alternate components, methods, and/or sub-systems may be substituted without departing from the scope hereof.

Also, alternate embodiments are envisioned in which the user devices 140a-d accesses one or more servers through a private network rather than via the Internet and a URL. The client 160a-b may host the private network with a server or other device including a client version of the sales system 100.

The computing system environment 150 includes a combination of one or more networks that are communicatively coupled to the sales system 100 and the user devices 140, e.g., such as a wide area network (WAN) 130 or a wireless wide area network (Wireless WAN) 132. The WAN 130 includes the Internet, service provider network, other type of WAN, or a combination of one or more thereof. The Wireless WAN 132 includes a cellular network, such as a 4G or 5G network. The WAN 130 or Wireless WAN 132 are communicatively coupled directly to a user device 140d or coupled to the user devices 140a-c through an edge network, e.g., including a router 136, bridge (not shown), or through a WLAN access point (AP) 134. The client router 136 may be coupled to a private client network, including e.g., a LAN 138 and/or a WLAN AP 144. The networks work to communicatively couple the user devices 140a-d to the application web server 110. Alternate networks and/or methods of communicating information may be substituted without departing from the scope hereof.

The application web server 110 includes, e.g., a network interface card (NIC) 112 that includes a transceiver for wireless and/or wired network communications with one or more of the user devices 140a-n over the exemplary networks 130, 132 in the computing environment 150. The NIC 112 may also include authentication capability that requires an authentication process prior to allowing access to some or all of the resources of the application web server 110. The NIC 112 may also include firewall, gateway, and proxy server functions.

The application web server 110 also includes a server processing circuit 114 and a server memory device 116. For example, the server memory device 116 is a non-transitory, processor readable medium that stores computer-executable instructions which when executed by the server processing circuit 114, causes the sales system 100 to perform one or more functions described herein. Computer-executable instructions may include, e.g., program modules such as routines, programs, objects, components, data structures, etc. that perform particular tasks or implement particular abstract data types. In the case of program code execution on programmable computers, the interface unit generally includes a processor, a storage medium readable by the processor (including volatile and non-volatile memory and/or storage elements), at least one input device, and at least one output device. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

The server memory device 116 is a non-transitory memory device and may be an internal memory or an external memory, and the memory device 116 may be a single memory or a plurality of memories. The memory device 116 may be a read-only memory, random access memory, volatile memory, non-volatile memory, static memory, dynamic memory, flash memory, cache memory, and/or any non-transitory memory device that stores digital information. The server processing circuit 114 includes at least one processor, such as a central processor unit (CPU), microprocessor, microcontroller, embedded processor, digital signal processor, media processor, field programmable gate array, programmable logic device, state machine, logic circuitry, analog circuitry, digital circuitry, and/or any device that manipulates signals (analog and/or digital) based on hard coding of the circuitry and/or operational instructions.

The server memory device 116 stores a sales application 118 including computer-executable instructions. The sales application 118 may be a web-based application supported by the application web server 110. For example, the application web server 110 may be a web server and provide access to the sales application 118, e.g., online via a website. In another embodiment, the sales application 118 is a stand-alone application that is downloaded to the user devices 140 by the application web server 110 and is operable on the user devices 140 without access to the application web server 110 or only needs to access the application web server 110 for additional data and updates.

The sales system 100 may further include a memory device 120, such as another server including RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, cloud devices, or any other medium which can be used to store the desired information and which can accessed by the application web server 110. The memory device 120 stores a database 122 with data 124a-n associated with a plurality of clients 160a-b. The client data 124a-n may be stored in a single database 122 or in separate databases 122, e.g., in a same or separate servers. The database 122 or portions of the user data 124a-n may also be stored in the server memory device 116 in the application web server 110. As may be appreciated, the database 122 may be any appropriate database capable of storing data, including without limitation cloud-based databases, and may be included within or connected to one or more servers similar to those described herein in any appropriate manner without departing from the scope hereof.

As used herein, the client 160a-b includes any organization or sales representative that uses or licenses the sales system 100 to document a potential sale to an End User or to document a sales opportunity of a product or service to an End User. The End User is the final consumer and user of a vendor offering and may include a “Champion” such as participant, stakeholder and/or leader of a project who internally endorses the client's product. The offering includes the products or services being offered to the End User. The client's relationship to the end user is the role of vendor, provider, and/or manufacturer of the offering.

The sales system 100 thus includes a special purpose processing system configured for provision of the sales application 118 to one or more user devices 140. The depicted computing system environment 150 is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like. The servers 110, memory devices 120, and databases shown in FIG. 1 are merely exemplary, and servers and/or databases may be omitted, added, or substituted without departing from the scope of the present invention.

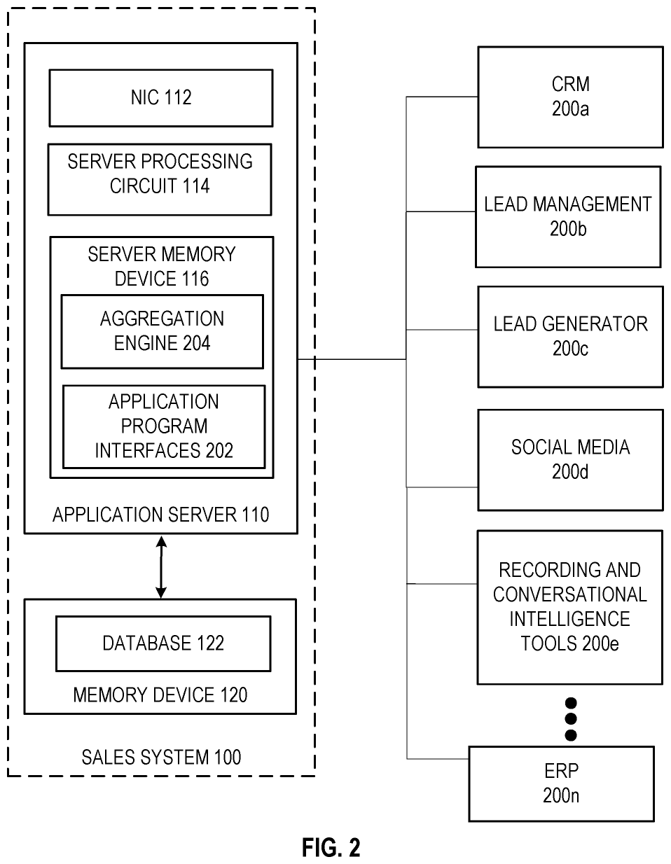

FIG. 2 illustrates an exemplary embodiment of the sales system 100 interworking with one or more other software systems 200a-n in accordance with one exemplary embodiment of the present invention. The software systems 200a-n may include client software systems, third-party software systems, publicly available software systems, etc. For example, the software systems 200a-n include, e.g., an End User relationship management (CRM) system 200a, a lead management system 200b, a lead generator system 200c, a social media system 200d, recording and conversational intelligence tools 200e, and/or an enterprise resource planning (ERP) system 200n. The social media system 200d may include Linkedin™, Facebook™, Twitter™, etc. Other systems 200 (not shown) may include an account and territory management system or other type of software system.

The sales system 100 includes application program interfaces (APIs) 202 for communicating with the one or more software systems 200a-n. The sales system 100 uses the applicable APIs 202 to retrieve data from the software systems 200a-n. The sales application 118 further includes an aggregation engine 204 that processes the data retrieved from the one or more software systems 200a-n and incorporates the data into the sales database 122. For example, when a client 160 has an account with a CRM system 200a, the sales system 100 may use an API 202 for the CRM system 200a to access the Client data and incorporate the Client data into the sales system 100. The Client 160 may then access the data through the sales system 100.

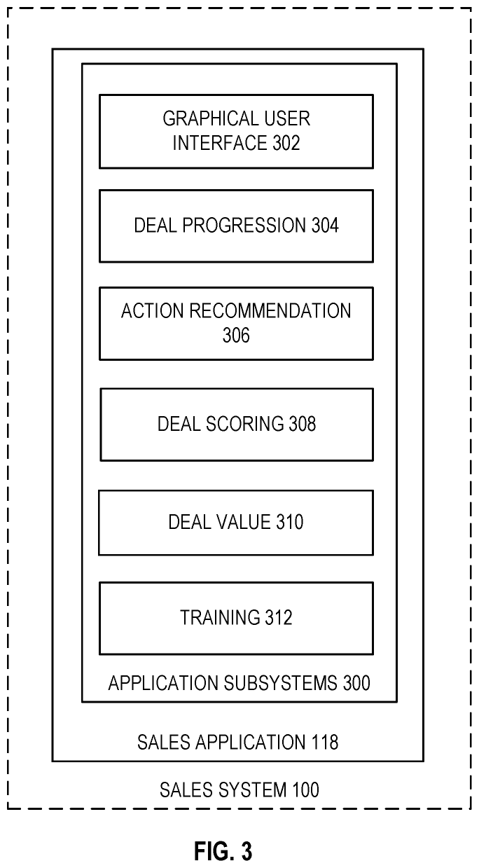

FIG. 3 illustrates an exemplary embodiment of one or more application subsystems 300 of the sales system 100 in accordance with one exemplary embodiment of the present invention. The application subsystems 300 are exemplary of the various functions of the sales system 100 and may be incorporated into a single software module or alternate or additional software modules. In an embodiment, the sales system 100 includes a graphical user interface (GUI) subsystem 302 that generates one or more GUIs, e.g., for display on the client devices 140a-n. For example, GUI subsystem 302 may generate GUIs including a dashboard that displays data to the Client 160 as described in more detail herein.

A deal progression subsystem 304 tracks one or more dimensions to a sales opportunity, wherein the one or more dimensions are generated according to a customizable theory of sales progress. The action recommendation subsystem 306 uses the theory of sales progress to analyse the current data using AI or neural network processes and determines recommendations for a sales representative. The sales representative of a Client inputs gathered information on a sales opportunity between the Client and an End User into the deal progression subsystem 304. Data from other software systems 200a-n may also be accessed and incorporated into the deal progressions subsystem 304. The action recommendation subsystem 306 analyses this information in making recommendations to the sales representative. The actions may include obtaining certain information, performing certain actions, or performing other next steps in the sales engagement. The action recommendations are used to coach sales representatives as they navigate sales opportunities.

The deal scoring subsystem 308 provides insights to the sales representative on the deal progression. The deal scoring subsystem 308 generates a “score” measuring a sales representative's progress in a sales opportunity. The GUI subsystem 302 then generates one or more GUIs that present the deal score to the sales representative. The sales system 100 grants points as the sales representative completes recommended actions and then presents updated scores, as if the sales representative is playing a game.

A deal value subsystem 310 generates a deal value, e.g., the expected value of a deal based on a current likelihood of success of closing the sale. A training subsystem 312 includes training materials (written, oral or video) that explain the rationale and strategy behind the recommendations such that a sales representative becomes more proficient. The sales system 100 thus makes the sales representative more effective in their sales role.

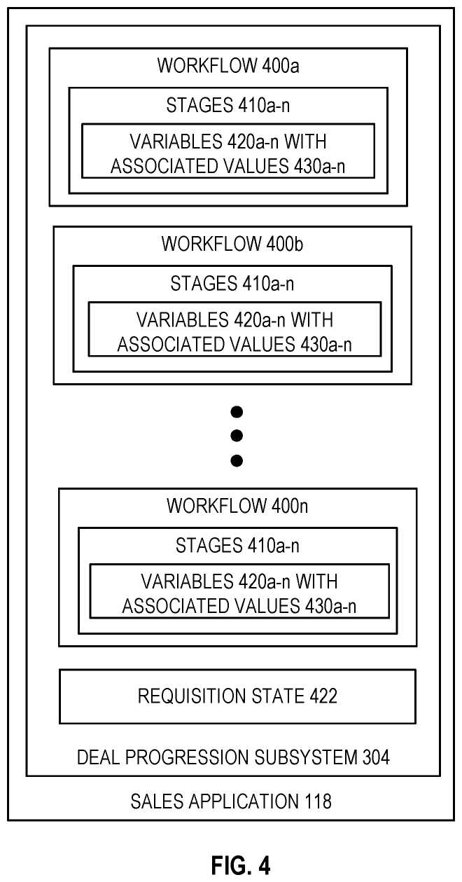

FIG. 4 illustrates an exemplary embodiment of a deal progression sub-system 304 of the sales system 100 in accordance with one exemplary embodiment of the present invention. The sales system 100 presents a sales opportunity as one or more exemplary dimensions or workflows 400a-n. In this example, the workflows 400 include budget, interest, time, and human. The workflows 400a-n each include one or more stages 410a-n, wherein each stage includes one or more features or variables 420a-n. Each variable 420a-n has an associated plurality of finite values 430a-n.

The sales system 100 tracks the progress of a sales opportunity for each of these workflows 400a-n. Additional or specialized workflows 400 may be created for other specific scenarios, such as completing a requisition process, helping end users in creating a request for proposal (RFP), or modifying an offer. The workflows 400 may be customized for different clients of the sales system 100 or for different types of sale offerings from a same client or for different potential End Users of a sales offering. For example, a Budget Workflow and Time Workflow may be the only workflows 400 required for certain sales opportunities, such as an anonymous bid on a government contract. The workflows 400 provide fact-gathering goals in the one or more stages 410a-n using the plurality of variables 420a-n.

Each stage 410 of a Workflow 400 may proceed to a requisition state 422, e.g., completion of the sales opportunity. Likewise, a sales opportunity has the possibility of re-starting from a previous stage. For example, an acquisition of a potential End User may occur in the middle of a proposed sales opportunity, and that may invalidate the previously ascertained budget source and availability.

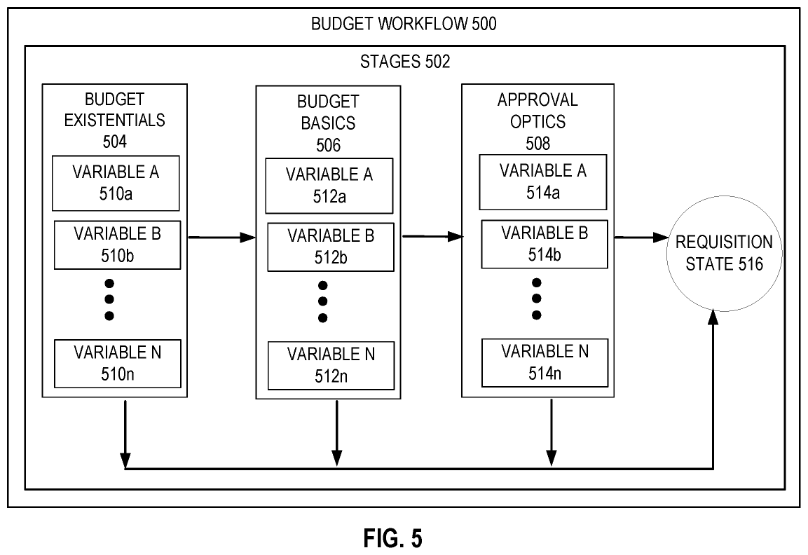

FIG. 5 illustrates an exemplary embodiment of a Budget Workflow 500 of the sales system 100 in accordance with one exemplary embodiment of the present invention. The Budget Workflow 500 includes a plurality of stages 502 and a requisition state 516. The plurality of stages 502 in this example includes budget existentials 504 with variables 510a-n, budget basics 506 with variables 512a-n, and approval optics 508 with variables 514a-n. These stages 502 are exemplary and additional and/or alternative stages 502 may be defined for the Budget Workflow 500.

The Budget Workflow 500 helps the sales representative understand the end user's budget characteristics, classification, availability, overall process while guiding to achieve optimal alignment with the offering. The plurality of variables in a stage each have an associated predetermined set of finite values. For example, in the Budget Existentials stage 504, the exemplary plurality of variables 510a-n and predetermined set of finite values for each of the plurality of variables 510a-n include the following:
Is it classified as an Operating Expense budget? [yes, no]
Is it classified as a Capital Expenditure budget? [yes, no]
Is it a discretionary budget? [yes, no]
Is it a monthly or annual budget? [monthly, annual]
Is there a configured matching proposal for monthly or annual budget? [yes, no, unknown]

The default value for a variable may be “unknown”. A limited or finite number of values or settings may be provided for a variable. For example, the variable “Is it classified as an Operating Expense Budget?” may only have the predetermined set of finite values: “yes” or “no” or the default “unknown”.

In one exemplary embodiment, the variables for a stage are expressed in logical expression functions, such as conjunctive normal form (CNF) logical formulas. Conjunctive normal form (CNF) is an approach to Boolean logic that expresses formulas as conjunctions of clauses containing ORs and negation operators. Each clause connected by a conjunction, or AND, must contain a sequence of 1 or more literals (or their negations) separated by OR operators. For example, an expression may consist of a conjunction of subexpressions each consisting of a single variable. The disjunctions of the variable would correspond to acceptable settings of the variable (or the negation). Other disjunctions may include distinct variables and their settings (or negation). Other logical expressions may be used such as “GREATER THAN” or “LESS THAN OR EQUAL” or “EQUAL”. Using logical expressions, the sales system 100 describes stage satisfaction rules for determining the completion of a stage. The stage satisfaction rules may include a sequence of function applications wherein the last function application in the sequence of function applications is a logical expression evaluating to True or False.

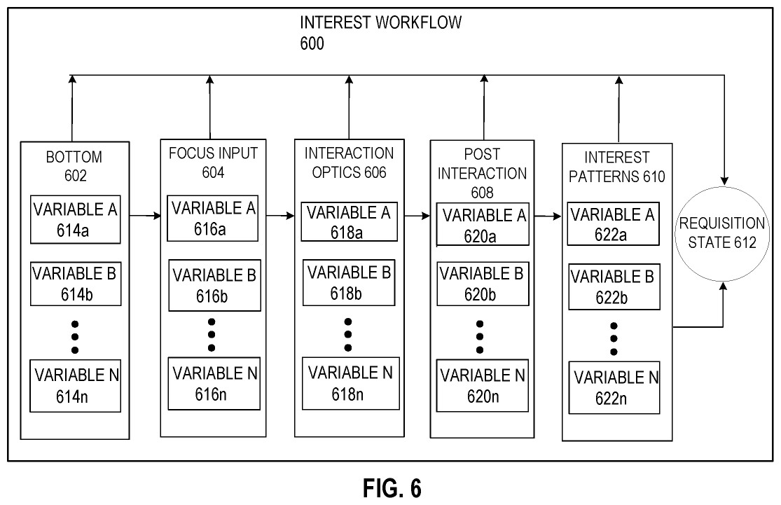

FIG. 6 illustrates an exemplary embodiment of an Interest Workflow 600 of the sales system 100 in accordance with one exemplary embodiment of the present invention. The Interest Workflow 600 measures the degree of motivating interest between the end user's need and the available offerings. The Interest Workflow 600 in this example, includes requisition state 612 and the following stages: Bottom stage 602 with associated variables 614a-n, Focus Input stage 604 including associated variables 616a-n, Interaction Optics stage 606 including variables 618a-n, Post Interaction stage 608 including variables 620a-n, and Interest Patterns 610 including variables 622a-n.

The Interest Workflow 600 measures a level of motivating interest, e.g., the interest that a potential End User may have in the offering and the interest of the Client in the sales opportunity. For example, the Interaction Optics stage 606 of the Interest Workflow 600 measures the degree of interest of an end user use case alignment in a sales opportunity in addition to the sales representative's progress in achieving this understanding. This factor helps determine whether the end user has sufficient interest for the sales representative to continue pursuing the sales opportunity. The Interaction Optics stage 606 requests data on a plurality of objective attributes, wherein the objective attributes logically imply the degree of interest of the end user. When the client's offering includes a data storage system, the plurality of variables 618a-n and associated finite set of values for the Interaction Optics stage 606 may then include the following:
offline_interest_in_datastorage: [yes, no]
OR interest_in_on_premise_datastorage: [yes, no]
OR interest_in_cloud_datastorage: [yes, no]
   AND
interest_in_high_performance_datastorage: [yes, no]
OR interest_in_mid_performance_datastorage: [yes, no]
OR interest_in_low_performance_datastorage: [yes, no]
   AND
datastorage_capacity_large: [yes, no]
OR datastorage_capacity_medium: [yes, no]
OR datastorage_capacity_small: [yes, no]

The above variables are expressed as logical expression functions of a plurality of series of “OR” functions. The “OR” functions may be linked by an “AND” function. In another example, the following variables are included in the Interaction Optics stage 606.
enduser_usecase_technical_requirements: [green, yellow, red, unknown]—the sales representative determines the End User's technical requirements and determines if vendor offering meets these technical requirements
enduser_technical_areas_of_interest: [green, yellow, red, unknown]—the sales representative determines whether the vendor offering maps to the top goals of the End User for project success
enduser_project_plan: [green, yellow, red, unknown]—the sales representative determines whether vendor offering meets the phases of project selection and success milestones from beginning to completion
enduser_project_engagement_process: [green, yellow, red, unknown]—the sales representative knows the key project participants, leads, champions, supporters, executives, decision makers and opposers

These variables measure objective attributes that logically imply the degree of mutual fit of the End User. The variables have four possible values: unknown, red, yellow, and green. In an example of stage satisfaction rules, the implication rule assigns a value of 1 when the value is green, 0.5 when yellow, and 0 otherwise to generate a value for the variable enduser_interest_in_offer_qualified_score. In this example, the implication rule is that the variable enduser_interest_in_offer_qualified_score must be greater than a minimum threshold of 3. The final stage satisfaction rule is that the value of the variable enduser_interest_in_offer_qualified_score must be greater than 3 to establish a sufficient degree of interest of an End User in a sales opportunity. The Interaction Optics stage 606 thus measures a degree of mutual fit of an End User in a sales opportunity using objective attributes, implications rules and logical expressions.

The above variables are exemplary and additional and/or alternate variables and associated values may be implemented. These variables and values were customized for a client with a product offering including data storage systems. The variables and associated values for a stage may thus be customized for a client, e.g., depending on the client's products, industry, type of End Users, etc. The stages of a workflow may also be customized. For example, the stages of Bottom 602, Focus Input 604, Interaction Optics 606, Post Interaction 608, and Interest Patterns 610 are exemplary and alternate and/or additional stages may be incorporated.

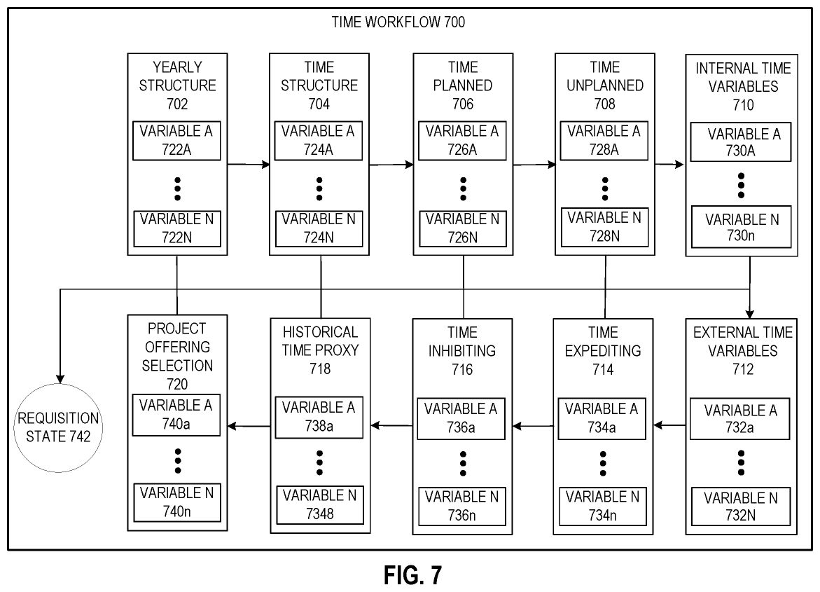

FIG. 7 illustrates an exemplary embodiment of the Time Workflow 700 of the sales system 100 in accordance with one exemplary embodiment of the present invention. The Time Workflow 700 in this example, includes the following stages: Yearly Structure 702, Time Structure 704, Time Planned 706, Time Unplanned 708, Internal Time Variables 710, Project Offering Selection 720, Historical Time Proxy 718, Time Inhibiting 716, Time Expediting 714, and External Time Variables 712. The plurality of stages 700 in the Time Workflow 700 also includes a plurality of variables 722a-n, 724a-n, 726a-n, 728a-n, 730a-n, 732a-n, 734a-n, 736a-n, 738a-n, and 740a-n.

The Time Workflow 700 determines a series of steps, factors, and variables that impacts the End User in making a decision on which vendor and offering to select for the identified sales opportunity. For example, the plurality of variables 724a-n and associated set of finite values for the Time Structure stage 704 may include the following:
enduser_team_review: [yearly,biyearly,quarterly,monthly,biweekly,weekly,daily]
enduser_testing_window: [yearly,biyearly,quarterly,monthly,biweekly,weekly,daily]
enduser_funding_request: [yearly,biyearly,quarterly,monthly,biweekly,weekly,daily]
enduser requisition_request: [yearly,biyearly,quarterly,monthly,biweekly,weekly,daily]
enduser_purchase_request: [yearly,biyearly,quarterly,monthly,biweekly,weekly,daily]
enduser_network_change: [yearly,biyearly,quarterly,monthly,biweekly,weekly,daily]
enduser_production_change: [yearly,biyearly,quarterly,monthly,biweekly,weekly,daily]
enduser_test_approval: [yearly,biyearly,quarterly,monthly,biweekly,weekly,daily]

The above variables 724a-n are exemplary and additional or alternate variables and associated values may be implemented. These variables and values were customized for a client with a product including data storage systems. The variables and associated values for the stage may be customized for a client, e.g., depending on the client's products, industry, type of End Users, etc. The states of a workflow may also be customized. For example, the time stages 700 are exemplary and alternate or additional time stages 700 may be incorporated.

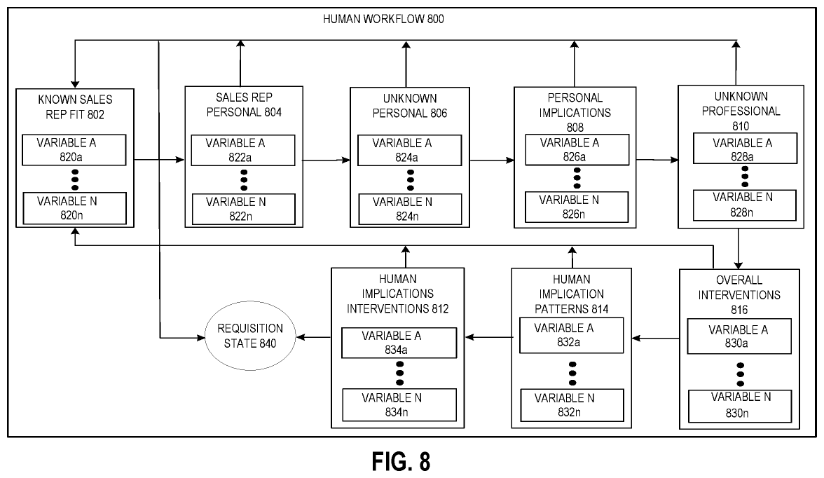

FIG. 8 illustrates an exemplary embodiment of the Human Workflow 800 of the sales system 100 in accordance with one exemplary embodiment of the present invention. The Human Workflow 800 in this example includes the following stages: Known Sales Representative (Rep) Fit 802, Sales Rep Personal 804, Unknown Personal 806, Personal Implications 808, Unknown Professional 810, Overall Interventions 816, Human Implication Patterns 814, Human Implications Interventions 812. The plurality of stages in the Human Workflow 800 also includes a plurality of variables 820a-n, 822a-n, 824a-n, 826a-n, 828a-n, 830a-n, 832a-n, and 834a-n.

The Human Workflow stage 800 measures the degree of understanding and alignment of End User participants engaged throughout the sales process. End user participants may include various stakeholders including project leads and “champions” (those who promote the offering internally within the organization). Current sales systems today only consider “rational” factors, where rational factors refer to what is best for the organization. Rational factors include the technology alignment with end users use case, ability for a solution to meet the requirements of the project, and the pricing of the offering in relation to the budget.

The sales system 100 described herein additionally measures irrational factors as well as rational factors in the sales opportunity. These irrational factors include, e.g., champion credibility, outcomes of past projects that the stakeholder or champion participated in, organizational political dynamics, degree of progressiveness (tendency to explore new technologies), insight to the end user's career objectives, the interpersonal dynamics between the end user and the sales representative, the end user's perception of the vendor, self-motivated idiosyncrasies, narcissism, and the amount or type of work required to integrate the offering into the use case. For example, the Unknown Personal stage 806 of the Human Workflow 800 includes information gathering type actions to determine common attributes between the sales personnel and the potential “champion” of the sales opportunity or lead of the project in the End User's organization. The common attributes may infer a platonic fit or good working relationship between the sales personnel and the potential “champion” or lead of the project. This interpersonal dynamic may positively or negatively affect the sales opportunity. The stage satisfaction rules include logical implication rules applied to the common attributes. Implication, in logic, means a relationship between two propositions in which the second is a logical consequence of the first, which is read “If A, then B,” and is denoted by A⊃B or A→B. The implication rules are applied in two sub-stages in the Unknown Personal stage 806 in this example.

In the first sub-stage, the variables include lists of related attributes. The sales representative of the Client must determine whether the attributes match with the End User personnel of the project in the sales opportunity (such as the project lead, business unit lead, etc.). When there is a match, the variable value is set to “yes”. When not a match, the variable value is set to “no”. The implication rules then express these cardinal values of “yes” or “no” into ordinal or categorical values or other types of values for comparison. For example, the implication rules may provide that none or one “yes” values in a list of sub-variables equals 0 for that list, two “yes” equals 1 for the list, and three or more “yes” values equal 2 for the list.

A threshold field then indicates the number of minimum attributes (e.g., sub-variables) with matches required for the ordinal value of 0, 1 or 2. Below is an example of two lists of sub-variables and the assigned ordinal value.

```
operator: count_bucketizer
inputs: [“platonic_fit_social_chemistry: no”,
  “platonic_fit_social_network:yes”,
  “platonic_fit_social_proxy:no”]
output_name: platonic_fit_social [platonic fit social = 1]
operator: count_bucketizer
inputs: [“platonic_fit_education_type:yes”,
  “platonic_fit_education_institution:no”,
  “platonic_fit_education_influences:yes”,
  “platonic_fit_education_subject:yes” ]
output_name: platonic_fit_education [platonic fit education = 2]
```

The implication rule for this first sub-stage computes an ordinal value 0, 1, and 2 for each of the variables platonic_fit_social and platonic_fit_education depending on the number of “yes” values in the list of sub-variables. Additional sets of the variables may be computed similarly in addition to these two variables, and examples are listed below. Thus, an ordinal value is assigned to each set of variables depending on a number of “yes” or “no” or other cardinal values of the plurality of variables in the set.

In the second sub-stage, the implication rule uses a sum of the ordinal values for each of the plurality of sets computed in the first sub-stage to generate an overall integer value for “platonic_fit.”

```
operator: sum
  inputs:
    [“platonic_fit_social ”,
      “platonic_fit_education”,
      “platonic_fit_political_view”,
      “platonic_fit_viewpoint_general_antagonist”,
      “platonic_fit_associations_family”,
      “platonic_fit_associations_meetups”,
      “platonic_fit_associations_music”,
      “platonic_fit_associations_art”,
      . . .
      “platonic_fit_education_institution”,
      “platonic_fit_education_influences”,
      “platonic_fit_education_subject”, ]
  output_name: platonic_fit
```

The second sub-stage thus generates a total ordinal value equal to the sum of the ordinal values of the sets of variables computed in the first sub-stage.

The stage satisfaction rule then measures whether the total ordinal value is greater than a predetermined threshold, as follows:
flow stage: human:unknown_personal_actions
conditions: [“GREATER_THAN(platonic_fit, 7)” ]

The logical expression “GREATER THAN” is the final stage satisfaction rule with an output of either True or False. The stage satisfaction rule measures whether the sales representative has identified a minimum threshold of platonic fit variables with the project lead (or other project personnel) of the potential End User. If not, the sales representative may not have collected sufficient data yet or may not sufficiently understand the End User lead. The sales system 100 may then recommend an action to obtain more data about the End User lead. The sales system 100 provides recommended actions and training to guide the sales representative to better understand the End User lead and/or other personnel.

In addition, the gathering of the data helps the sales representative understand which topics to discuss or avoid. It gives the sales representative an overall idea of the dynamics of the interpersonal relationship, and the nuanced characteristics of the End User's project lead. It helps the sales representative learn about the personality traits, etc., of the End User's project lead with an eye towards how it guides their decision making and mode of interaction. It also gives the sales representative and the sales system 100 the information to determine whether bringing in extra or alternative personnel to meetings to develop the interpersonal relationship with the project lead of the End User would be useful.

In a stage, the sales system 100 may apply a secondary aggregate function to transform the ordinal values determined in each stage 400 for the different characteristics (platonic fit, career drivers, professional attributes, etc.) into an overall ternary score. The overall ternary score from all the stages 400 in the Human Workflow 800 may be used to rank the alignment of the End User lead as either towards, against or neutral to the offering and the sales representative.

The Human Workflow 800 thus measures the irrational factor of the working relationship between the sales personnel and an End User personnel using implication rules and objective data. Data on a plurality of objective attributes is collected, wherein the attributes logically imply the irrational factor. The attributes are expressed as variables with an associated set of finite values. Then an implication rule determines an ordinal value assigned to the values of the variables. The ordinal value may then be compared to a minimum threshold to measure the irrational factor. The implications rules set a threshold that must be met to logically infer the irrational factor from the objective attributes. The Human Workflow thus measures “irrational” factors in a sales opportunity using implication rules and objective attributes. These same methods may be used to measure the “rational” factors in a sales opportunity as well.

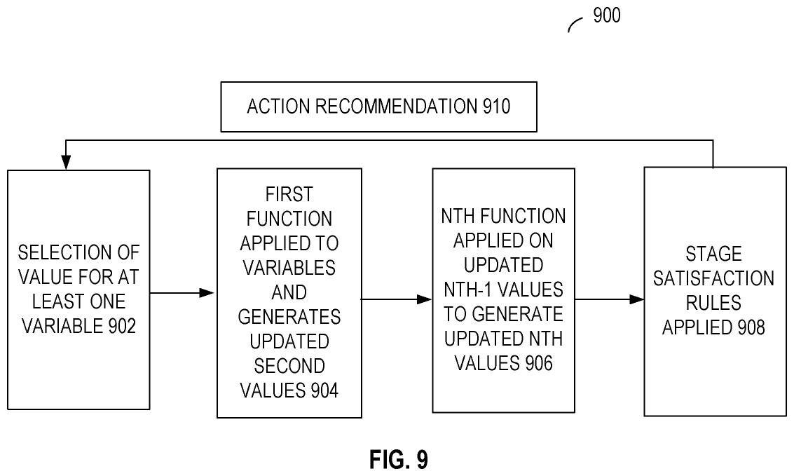

FIG. 9 illustrates a method 900 of processing the plurality of variables 420 in a stage 410 in accordance with one exemplary embodiment of the present invention. A stage 410 in a workflow 400 may employ variable aggregation using conjunctive normal form (CNF) satisfaction rules or other logical expressions. The stage 410 expresses the variables in one or more logical expressions. When the plurality of variables 420 in a stage 410 have been assigned a valid one of its associated set of finite values 430 in step 902, the logical expressions (e.g., the stage satisfaction rules in this example) indicate that the stage 410 is complete in step 908. Separate aggregation functions may be defined for different features or variables.

This type of stage satisfaction rule is shown with respect to the Budget Existentials stage 504 in FIG. 5. When each of the plurality of variables has a selected value (e.g., “yes”, “no” or “annual” or “monthly”), then the logical expressions indicate that the Budget Existentials stage 504 is complete. When the logical expressions (e.g., the stage satisfaction rules in this example) indicate that the stage 410 is not complete in step 908, an action recommendation may be generated in step 910.

In another embodiment, a stage 410 may also include functions applied to the values of the variables or a sequence of functions applied to the variables in steps 904 and 906. For example, a first function is applied to the values of the variables in step 904. The output of the first function in step 904 generates updated second values. A number N of functions may be applied to the Nth-1 values. The Nth-1 values may be expressed in the form of additional features to which an Nth function is applied in step 906 to generate the Nth values. The stage satisfaction rules in step 908 are then applied to the Nth values. An example of this type of stage satisfaction rules is shown with respect to the Personal Implications stage 808 of the Human Workflow 800 in FIG. 8. Thus, the logical expression formulas that determine the satisfaction of the stage's requirements may be computed on the values of the stage variables or to the Nth updated values constructed via a sequence of functions applied to the Nth-1 updated values.

One type of function could be a binning function to aggregate diverse values 430 into a ternary (such as red/yellow/green) indicator of a completion of a stage 410. Separate aggregation functions may be defined for different variables 420. The secondary functions may then perform secondary aggregation over the initial aggregates. For example, a secondary aggregate function may transform the ternary settings for the different variables into an overall ternary score for the stage 410.

In addition to measuring irrational and rational factors, the sales system 100 may measure other relevant non-utility factors. For example, the sales system 100 may measure the extent a potential End User is “progressive” or “conservative”. A progressive End User is generally an early adopter of new technology and more likely to adopt new paradigm shifting and disruptive technologies. A conservative End User is less likely to adopt new paradigm shifting and disruptive technologies. A progressive End User is more likely to source from start-ups or from non-incumbent vendors. A conservative End User is more likely to source from incumbent vendors.

In the Interest Workflow 600 shown in FIG. 6, the sales system 100 uses past decisions by vendor classification of start-ups to measure the relative level of progressive and conservative tendencies of the End User. The below variables and logical expressions are defined as part of the Post Interaction Stage 608 of the Interest Workflow 600:
Lead_technical_shared_services_project_aligns_past_projects_vendor_selection_pro_st artup: {yes, no}
   OR lead_business_unit_project_aligns_past_projects_vendor_selection_pro_startup: {yes, no}
   OR
lead_application_team_project_aligns_past_projects_vendor_selection_pro_startup: {yes, no}
   OR lead_sourcing_project_aligns_past_projects_vendor_selection_pro_startup: {yes, no}
   OR lead_architect_project_aligns_past_projects_vendor_selection_pro_startup: {yes, no}

The variables relate to whether personnel of the End User (such as technical lead, business unit lead, application team lead, sourcing lead, or architect lead) have selected start-ups in past projects. The sales system 100 uses these variables to measure the level of progressiveness or conservatism of an End User. In another example, the Post Interaction Stage 608 defines variables relating to whether personnel of the End User have selected progressive or conservative vendors, such as:
enduser_current_project_aligns_past_projects_vendor_selection_progressivenes s: {yes, no}
   OR
lead_technical_shared_services_project_aligns_past_projects_vendor_selection_progressiveness: {yes,no}
   OR
lead_business_unit_project_aligns_past_projects_vendor_selection_progressive ness:{yes,no}
   OR
lead_application_team_project_aligns_past_projects_vendor_selection_progress iveness:{yes,no}
   OR
lead_sourcing_project_aligns_past_projects_vendor_selection_progressiveness: {yes,no}
   OR
lead_architect_project_aligns_past_projects_vendor_selection_progressiveness: {yes,no}

The above variables are used to determine the past vendor selections of the project personnel. The following “stage satisfaction rules” may be applied to these variables.
End User Progressive
Lead Progressive (for each category of lead)
State of progressiveness depends on the combined contribution percentage of
Lead Progressive to the overall group. Likewise, the above variables label the
conservativeness of participants and stakeholders.
End User Conservative only exists if any lead is marked conservative
Lead Conservative (for each category of lead)
State of conservativeness depends on combined contribution percentage of Lead
Conservative to the overall group of stakeholders.

In another example, the Bottom Stage 602 of the Interest Workflow 600 includes variables to directly identify the level of overall end user progressiveness from past decisions such as:

| | |
|---|---|
| - | flow_stage: interest:bottom |
| | conditions: |

| | |
|---|---|
| - | “offline_interest_in_datastorage:yes” |
| - | > |
| | progressive_company: yes |
| | OR conservative_company: yes |

The Sales Representative may input the type of company, progressive or conservative, if known. The sales system 100 may use this information to recommend actions and determine the probability of success of the sales opportunity and/or the deal value. For example, when the Client is an incumbent and the potential End User is an existing “Conservative” customer, then the recommended actions and/or training are selected for this situation, and the probability of success is increased. However, when the Client is a start-up with new disruptive technology and the potential End User is a Conservative new customer, then the probability of success is decreased by the sales system 100. The sales system 100 also adjusts the recommended actions and training modules for this situation.

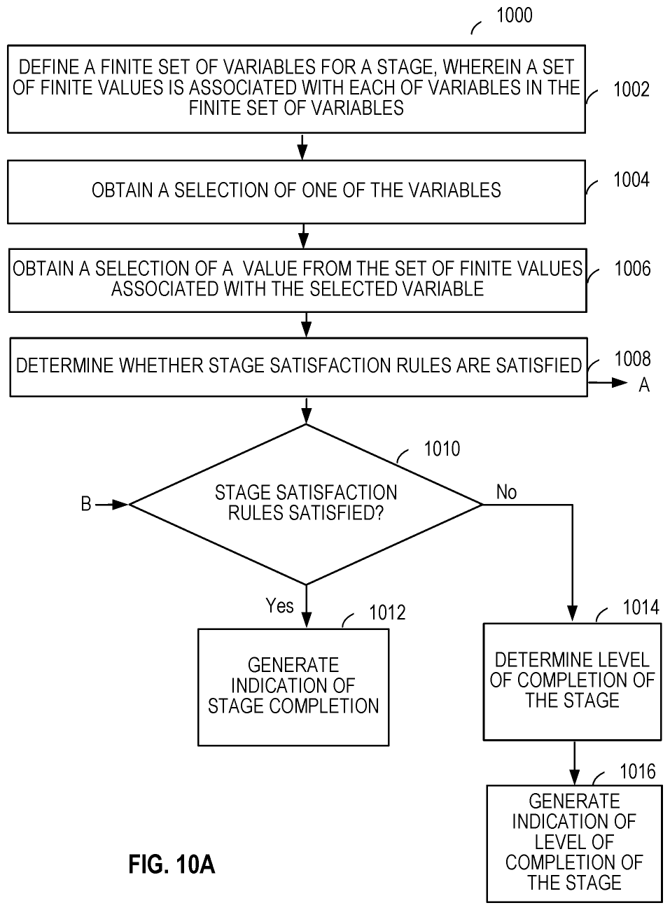

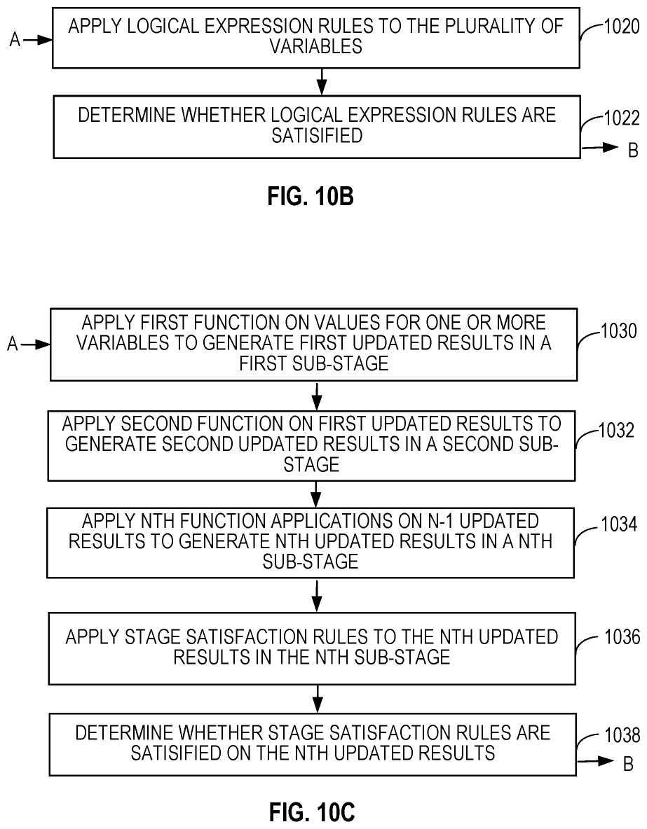

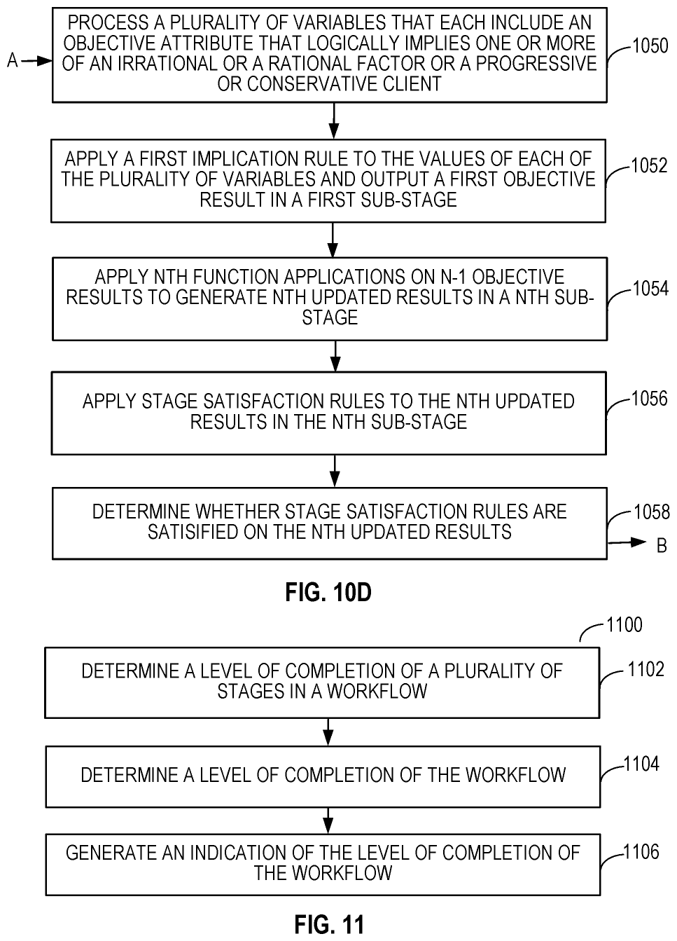

FIG. 10A illustrates a method 1000 for stage completion in accordance with one exemplary embodiment of the present invention. In 1002, the sales system 100 presents to a Client (e.g., in one or more GUIs) a plurality of variables for at least one stage 410 of at least one workflow 400. A selection of at least one of the plurality of variables is obtained in 1004. For example, the sales system 100 may receive the selection from a browser 140 of a user device 140 of a client 160. The browser 142 of the user device 140 may use HTTP or other communications protocol to communicate the selection in the computing environment 150 to the sales system 100. In response to the selection, a GUI may be generated by the GUI subsystem 302 for display on the user device 140, wherein the GUI includes a set of finite values associated with the selected variable.

In 1006, a selection of one of the values in the associated set of finite values is obtained, e.g., from the user device 140. The sales system 100 may then record the selected value of the selected variable in a memory device 120, e.g., such as in a database with the client data. At 1008, it may then be determined whether the stage satisfaction rules are satisfied. For example, when a variable value is updated in a stage 410, the sales system 100 may automatically perform the stage satisfaction rules associated with the stage 410 to determine whether the stage 400 is complete at 1010. When the stage 410 is complete, an indication of the stage completion may be generated at 1012. For example, an icon in a GUI representing the stage 410 may be altered to indicate completion, such as changed to another color, or flash, and/or have a check mark added, etc.

When the stage 410 is not complete, a level of completion of the stage 410 may be determined at 1014. An indication of the level of stage completion may be generated at 1016. For example, an icon in a GUI representing the stage 410 may be altered to indicate the level of completion, such as changing the color or including a percentage complete indicator, etc.

At 1008, the determination of whether the stage satisfaction rules are satisfied may be performed using one or more different methods depending on the stage. Referring to FIG. 10B, a method is illustrated for determination of whether the stage satisfaction rules are satisfied in accordance with one exemplary embodiment of the present invention. Logical expression rules are applied to the plurality of variables, e.g., using one or more CNF expressions. The rules are expressed in formulas as conjunctions of disjunctive clauses which may include negations over the variables. For example, the different variable settings are interpreted as disjunctions, whereas the variables are separated by clauses joined by AND operators. Using logical predicates, the sales system 100 determines whether the stage satisfaction rules are satisfied at 1022. When each of the plurality of variables 420 in a stage 410 have been assigned a valid one of its associated set of finite values 430, the logical expressions (e.g., the stage satisfaction rules in this example) indicate that the stage 410 is complete.

FIG. 10C illustrates another method for determination of whether the stage satisfaction rules are satisfied in accordance with another exemplary embodiment of the present invention. In this method, one or more functions are applied to the variables 420 in a stage 410. For example, at 1030, in a first sub-stage, a first function is applied to the values of one or more variables in a stage to generate first updated results. At 1032, in a second sub-stage, a second function may be applied to the first updated results to generate second updated results. In this manner at 1034, in an Nth sub-stage, a number N of functions may be applied to the Nth-1 updated results to generate the Nth updated results. The stage satisfaction rules are then applied to the Nth updated results at 1036. The final stage satisfaction rule may be a logical expression with a True/False output, and using this output, it is determined whether the stage satisfaction rules are satisfied at 1038.

FIG. 10D illustrates a method for determination of whether the stage satisfaction rules are satisfied for a stage in accordance with another exemplary embodiment of the present invention. When measuring irrational factors or rational factors, implication rules are used to help measure the factors. The implication rules measure a relationship between two propositions in which the second is a logical consequence of the first, which is read “If A, then B,” and is denoted by A⊃B or A→B. The B is the irrational or rational factor in this case, and the A is one or more attributes or variables of the stage that logically infer the factor. For example, a high degree of similarity in the objective attributes of education, social interests, political views, family structures, religions, etc. may logically be used to infer the basis for the sales representative to build camaraderie during conversation. Or a high percentage of past purchases from start-ups may logically be used to infer that an End-User is a “Progressive” type customer. The implications rules determine a threshold that must be met to logically infer the non-utility factor from the objective criteria.

At 1050, a plurality of variables that measure objective attributes are processed using one or more implication rules, e.g., wherein the objective attributes logically infer an irrational factor or a rational factor or progressive or conservative customer. For example, at 1052, in a first sub-stage, a first function is applied to the plurality of values of the plurality of variables to generate a first objective result. The objective result may include an ordinal value or percentage or rank, etc. At 1054, in this manner, in an Nth sub-stage, a number N of functions may be applied to the Nth−1 objective results to generate the Nth objective results. The stage satisfaction rules are then applied to the Nth objective results at 1056, and it is determined whether the stage satisfaction rules are satisfied at 1058. The sales system 100 may thus generate an objective measure of both irrational factors and rational factors relating to a sales opportunity or to other factors, such as conservative/progressive type End Users.

A plurality of variables may include objective attributes that logically imply both an “irrational” and a “rational” factor. For example, in the Unknown Professional stage 810 of the Human Workflow 800 two variables include the following.
decision_trend_storage_rational_stability [yes]
decision_trend_storage_irrational_vendor_expense_budget [yes]

In this example, both variables have a value of “yes”. An end user's decision tends to focus on which product has the most stability—which is a “rational” factor. The End User may also have a tendency to select a vendor with the largest entertainment expense budget which is an “irrational” factor. The “rational” factor represents what is best for the end user organization, such as a stable product with the lowest failure rate. The “irrational” factor represents what is best for individuals of the End User, such as the sales representative's entertainment expense budget that allows those End User individuals to enjoy entertainment in the form of free meals, games, apparel, money toward personal non end user functions. Both factors are considered as part of a vendor selection process, and thus measured by the sales system 100. In another practical example, the individuals of an end user may be restricted from being “entertained” by a sales representative, and then the“irrational” factor is indicated as “no”.

In addition, the factors of a “Progressive” or “Conservative” End User are measured by the sales system 100. The sales system 100 may measure other factors, such as platonic and intrinsic factors. Platonic Factors are attributes that both the sales representative and end user personnel align on based on their background, pedigree, education, social status, interests, and general shared associations and interests. Intrinsic Factors are attributes that both the sales representative and end user personnel naturally feel comfortable and align on from the nature of their personality and character. For example, the variable, “Intrinsic_fit_enjoy_time_with vendor:{yes,no}” measures an intrinsic factor of whether the vendor and end user truly enjoy spending time with each other. The sales system 100 thus measures non-utility and utility type factors, such as rational/irrational factors, as well as progressive/conservative factors, intrinsic factors, platonic factors, etc.

FIG. 11 illustrates a method 1100 for determining a completion level of a workflow 400 in accordance with one exemplary embodiment of the present invention. The completion level may refer to a percentage, a relative level (none, low, mid, high, complete), a quality factor or a combination thereof. At 1102, the completion level of each of the plurality of stages 410 in the workflow 400 are determined. Using the completion level of each of the plurality of stages 410, the level of completion of the workflow is determined. The completion level of the workflow 400 may be a mean, average or sum of the completion levels of the plurality of stages 410. An indication of the level of completion of the Workflow 400 is generated at 1106. For example, an icon in a GUI representing the Workflow 400 may be altered to indicate the level of completion, such as changing the color of the icon and/or updating a percentage complete indicator.

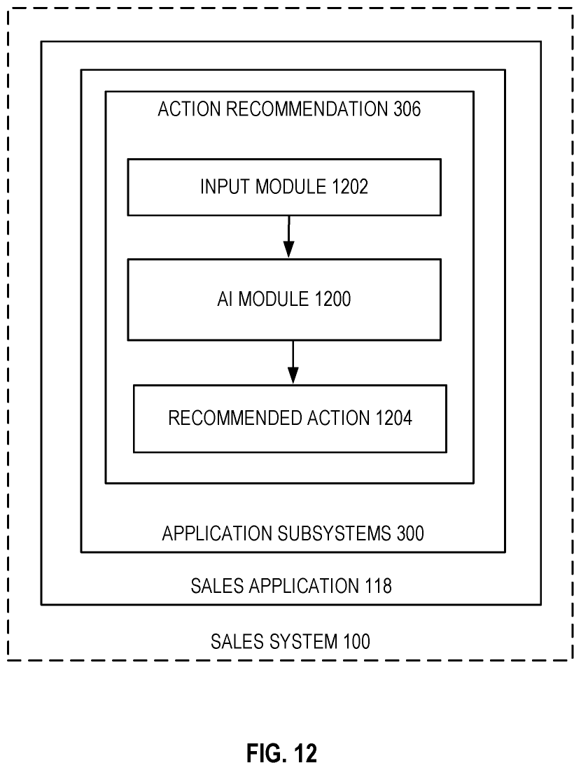

FIG. 12 illustrates an exemplary embodiment of the action recommendation sub-system 306 of the sales system 100 in accordance with one exemplary embodiment of the present invention. The action recommendation sub-system 306 may include separate software components, and/or include software components in one or more of the other sub-systems, that are stored on a memory device, such as memory device 116 or other memory devices. The software components include instructions which when processed by at least one processing circuit, such as the server processing circuit 114, cause the sales system 100 to perform one or more of the functions described herein.

The sales system 100 generates a recommended action to assist a sales representative in progressing a sales opportunity. The action recommendation sub-system 306 uses a dynamic artificial intelligence (AI) module 1200 that includes AI processes and/or other processes to generate the action recommendations. The AI module 1200 may include software components performing one or more of the following: neural network processes, machine learning processes or deep learning processes. The input module 1202 inputs the relevant information from one or more stages 410 of a workflow 400, and the AI module 1200 selects a recommended action 1204 from the plurality of predefined actions.

The recommended actions may be categorized as information actions or intervention actions. The information actions suggest obtaining additional information or data relating to the sales opportunity. For example, the action may recommend that a sales representative ask an End User, “Are you using a Capital Expenditure budget for the sale?” to determine the value of the variable, “is_it_classified_as_capex_budget”, in the Budget Workflow 500.

The intervention actions recommend tasks to progress the sales opportunity. For example, if “is_it_classified_as_capex_budget” is indicated as “yes” intervention actions would include a recommendation and training module around building a pricing proposal geared toward a single capital budget purchase transaction. On the other hand, when “is_it_classified_as_opex_budget” is set to “yes”, and so indicating an operational expenditure, the recommendation may be, “Action 4001 description: Sales representative builds monthly subscription pricing proposal addressed to budget owner.” This intervention action is based on indicating both the opex budget rule as “yes” and information that this end user's opex budget is allocated monthly. The information and intervention actions together help the sales representative achieve completion of the stage through the stage satisfaction logical expressions.

In one embodiment, the AI module 1200 includes a Markov Decision Process (MDP) solver or other programming that uses a MDP model for a stage 410 of a workflow 400. The MDP model of a stage 410 includes a plurality of predefined states, actions, transition probabilities and rewards. The design of rewards, terminal states, and transition probabilities determines the recommended actions which are inferred automatically using an MDP solver. This approach differs from the conventional approach of an expert system design in which a domain expert creates a prescriptive rulebook that maps states to desired actions. The use of an MDP solver is much simpler than this manual approach of a prescriptive rulebook. By using computational techniques to determine the recommended action, the sales system 100 is easier to evolve and to customize. Additional actions may more easily be implemented without enumerating all the circumstances where the action should be applied. Instead, the domain expert need only specify rules for what is expected to change within the “virtual world” defined by the MDP model when the action is taken. Leveraging AI and optimization techniques, the sales system 100 provides a customizable sales planning system for providing optimal action recommendations.

The term “optimal” or “most optimal” (as well as derivatives and other forms of those terms and linguistically related words and phrases), as used herein, are not intended to be limited to the single absolute best decision provided all possible data. Instead, the terms refer to a mathematically optimal solution and not to the best of all mathematically available possibilities, real-world demonstrations of optimization routines, methods, models, and processes. Accordingly, a person of ordinary skill in the art having the benefit of the present disclosure will appreciate that these terms, in the context of the scope of the present invention, are more general. The terms “optimal” or “most optimal” rather describe the current mathematical solution given the input data, which may or may not be the best available solution.

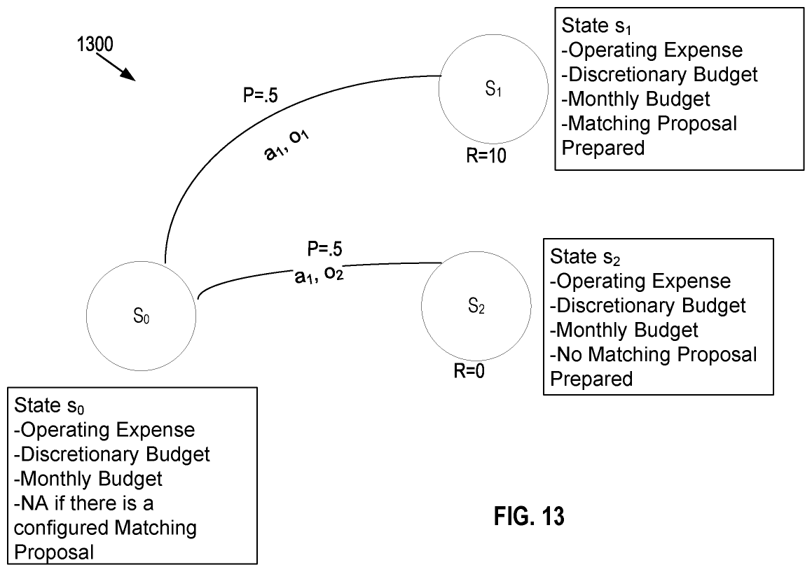

FIG. 13 illustrates an exemplary MDP representation 1300 of a stage 410 for action recommendation in accordance with one exemplary embodiment of the present invention. In this example, an exemplary initial state (s₀) from the Budget Existentials stage 504 of the Budget Workflow 500 is shown in the MDP representation 1300. The exemplary initial state (s₀) is defined by the following set of values of the plurality of variables 510a-n included in the Budget Existentials stage 504:
Is it classified as an Operating Expense budget? [yes]
Is it a discretionary budget? [yes]
Is it a monthly or annual budget: [monthly]
Is there a configured matching proposal for the monthly budget: [unknown]

From these values in the initial state (s₀), it can be determined that the potential sales opportunity with the End User has an Operating Expense (OpEx) budget that is discretionary with a monthly cycle set of terms. However, the ‘unknown’ setting for the matching proposal feature indicates that the sales representative has made no attempt to prepare a monthly subscription proposal for the End User.

The first action a₁ is to prepare a monthly subscription proposal for the end user. From this initial state s₀, a first outcome o₁ is defined that the sales representative prepares the monthly subscription pricing proposal, e.g., to match the End User's budget categorization of a monthly cycle set of terms. This outcome o₁ corresponds to a new state s₁ defined by the variable “Is there a configured matching Proposal Prepared” with the value “yes”. The new state s₁ has an assigned reward of R=10 and a P=0.5 transition probability that has been configured for the first outcome o₁.

A second outcome o₂ is defined as the sales representative is not able to prepare a monthly subscription pricing proposal compatible with the budget constraints. For example, the sales representative may not obtain approval to discount the monthly price to a compatible level. This second outcome 02 corresponds to a new state s₂ defined by the variable, “Is there a configured matching Proposal Prepared” with a value “no”. The new state s₂ has an assigned reward of R=0 and a P=0.5 transition probability that has been configured for the second outcome o₂.

From this MDP representation 1300, it is straightforward to determine that the expected reward for action a₁ at state s₀ is 5 (plus any expected future reward beyond the one step horizon). The sales system 100, e.g., using the AI module 1200 that includes the MDP parameters for a stage and an MDP solver, may then recommend the action at from this exemplary initial state s₀, e.g., assuming its reward is higher than the other available actions at this stage. The action at is shown in Table 1 below with the description: Sales representative builds monthly subscription pricing proposal addressed to budget owner.

The rewards R for each of the plurality of predefined states in a stage 400 may initially be assigned in configuration files. The rewards R are associated with the current state s₀, the new state s′ after transition, and the action that was taken. The rewards R may be updated over time using AI techniques such as apprenticeship learning or inverse reinforcement learning, as data is collected from a client's implementation and use of the sales system 100. The logical expression language used for stage satisfaction rules can apply to reward matching as well.

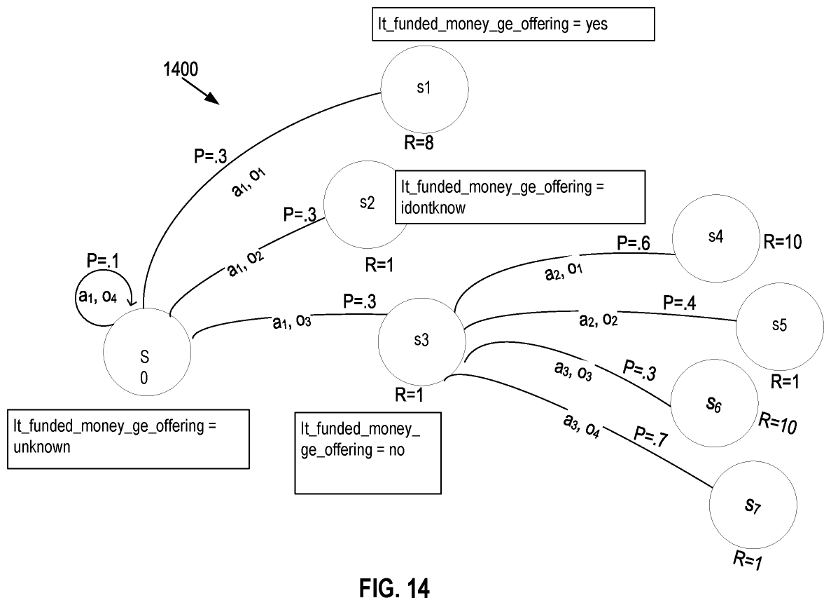

FIG. 14 illustrates an exemplary MDP representation 1400 of another stage 410 for action recommendation in accordance with one exemplary embodiment of the present invention. In this example, the approval optics stage 508 of the Budget Workflow 500 includes an initial state s₀ wherein a first variable 514a of the Client's approved offering price to a potential End User is known. However, a second variable 514b named “it_funded_money_ge_offering” of whether the funded budget of the End User meets the approved offering price is unknown. The initial state s₀ is defined by this set of values of the variables.

The variable “it_funded_money_ge_offering” has four values, yes, no, idontknow, and unknown. So, the action a₁ of determining whether the funded budget of the End User meets the approved offering price has four possible outcomes. In a first outcome o₁, the approved offering price is determined to be below the funded budget of the End User. This outcome o₁, initial state s₀ pair leads to the new state s₁, wherein the variable “it_funded_money_ge_offering” is set to ‘yes’. If it cannot yet be determined, e.g., the End User has not disclosed an approved budget, the variable “it_funded_money_ge_offering” is set to ‘idontknow’ at the new state s₂. When the End User's approved funding is below the Client's approved offering price, the variable “it_funded_money_ge_offering” is set to ‘no’ at state s₃. If the variable “it_funded_money_ge_offering” remains at “unknown”, the state s₀ remains unchanged.

In response to the state s₃, other predefined actions a₂, a₃ may be presented to guide the sales representatives to overcome the gap between the End User's approved funding and the Client's approved offering price. For example, action a₂ may be to request approval of a lower offering price from the Client, with a possible outcome o_{f} of “yes” at state s₄ or a possible outcome o₂ of “no” at state s₅. In another example, action a₃ may be to request an increase in the approved funding from the End User at state s3, with a possible outcome of o₁ “yes” at state s₆ or a possible outcome o₄ of“no” at state s₇. When these actions are not possible, it may be required to recommend another action a₄ (not shown) to abort the sales opportunity. The actions and states in this FIG. 14 and in the prior FIG. 13 are exemplary. Alternate and/or additional states or actions may be implemented and customized for different End Users.

As seen in FIG. 13 and FIG. 14, arrival at each state is assigned a reward r and each outcome from taking an action is assigned a probability p. These probabilities p and rewards r are used to determine the optimal recommended action. The specification of these factors is used to build a simulator that an optimizer can explore iteratively to discover which actions give the best immediate and future rewards.

For example, from state s₃ in FIG. 14, the expected reward from taking action a₂ is 6.4 plus the probability weighted future rewards from states s₄ and s₅. The AI Module 1200 in this example uses the initial state s₀ of the stage 410, the predetermined plurality of actions a₁, a₂, a₃ for the stage 410, the probability p of the plurality of outcomes o₁, o₂, o₃ for the stage 410 from the initial state s₀ and the rewards r of the first generation of states s₀, s₁, s₂, s₃ generated from each action/outcome, initial state pair. In addition, the AI Module 1200 uses the Rewards R and the Probability P of the second generation of states s₄, s₅, s₆ and s₇ as well as the Rewards R and Probability P of the third, fourth, etc. generation of states.

The MDP model may thus be defined using the parameters (S, A, P, R), wherein:
S is a set of states called the state space
Aₛ is the set of actions available from a state s in the set of states S
Pₐ(s,s′)=Pr(sₜ₊₁=s′|Sₜ=s, a) is the transition probability that action a in state s at time t will lead to state s′ at time t+1
Rₐ(s,s′) is the immediate reward received after transitioning from state s to state s′ due to action a
   For a particular stage 410, the set of states are defined using the variables of the stage 410. For example, a unique set of values for the plurality of variables of the stage 410 is used to define each of the states. The stages 410 thus provide constraints on the number of possible states. The transition probabilities Pₐ(s,s′) may be based on data probability distributions or manually prescribed.

A stage 410 and its associated plurality of states and actions provides the stochastic environment for a Markov decision process (MDP) model. The plurality of states for a stage 410 may be defined using each unique set of values for the defined variables of the stage 410. However, this method may produce too large a set of states for efficient computation. In addition, when too many variables have unknown values, the MDP model may not be needed. For example, one of the recommended actions for a state with unknown values may be to continue to collect data for variables included in a stage 410. The recommended actions may include an optimal sequence for information gathering questions or include other actions.

To determine an optimal action, a policy n(s) may be found that maximizes a cumulative expected value V of the rewards R, typically the expected discounted sum of the rewards. The algorithm has two steps, (1) a value update V(s) and (2) a policy update n(s). Both algorithms recursively update a new estimation of the optimal policy n(s) and value V(s) using an older estimation of those values:

$$V ( s ) := {\sum }_{{s}^{′}} {P}_{π ( s )} ( s , {s}^{′} ) ( {R}_{π ( s )} ( s , {s}^{′} ) + γ V ( {s}^{′} ) )$$

$$π ( s ) := arg {max}_{a} \{ {\sum }_{{s}^{′}} {P}_{a} ( s , {s}^{′} ) ( {R}_{a} ( s , {s}^{′} ) + γ V ( {s}^{′} ) ) \}$$

wherein: γ is a discount factor
   V(s) is a value of the state s
   π(s) is a policy that maximizes the value V(s)

In one embodiment, the value V(s) is determined for each of the plurality of predefined actions A using the MDP parameters. For example, a reinforcement learning process may estimate the value function V and policy π of each state. An optimal policy π(s) and value V(s) are determined and used to select the one or more recommended actions. Rather than mapping a state-action pair to a value V, a Deep Learning approach, such as the Actor/Critic methodology, uses a neural network to map states to their values V(s) and policies π(s). The plurality of predefined states for a stage 410 may be defined using each unique set of values for the variables.

Reinforcement learning approaches such as the Actor/Critic method require a method for simulating the environment. One approach is to pick an initial state using a random configuration and then using the specified transition probabilities Pₐ(s,s′) to simulate the environment. This is the most natural method of casting the action recommendation problem as a Markov decision process, but assumes that the transition probabilities, rewards, etc., are accurate and easily learned by the MDP solver. This approach is undermined by the way the probability of successfully completing a sales opportunity diminishes exponentially as the number of requirements increases when using independent probability formulation (as in the exemplar transition configuration for transition probabilities). Exponentially decreasing success probability impacts inference convergence time in a reinforcement learning formulation of the planning problem.

Another method to implement the Markov decision process of a stage 410 is by sampling from the set of variable/value configurations that satisfy the stage. These settings are “hidden” from the learning agent until such time as an explored action “uncovers” their value. This approach does not attempt to model the real world faithfully. Instead, it provides training designed to guide an AI agent to learn the behaviour desired in the real world. When the stage satisfaction rule definitions and implications are restricted appropriately (for example when literals appear at most once in the stage satisfaction expression or any input to an implication rule), acceptable configurations for stages may be sampled and identified in polynomial time. The logical implication rules and stage satisfaction rules are constrained to provide a polynomial time algorithm for sampling from stage satisfying variable configurations. This algorithm over restricted rules starts by sampling a stage satisfaction rule and setting variables accordingly. Then the algorithm iterates backwards over the implication chain setting the input variables in a way that generates the desired output. Determining essential variable settings in this regime is a backward sweep initiated from a stage satisfaction rule and passing over the implication chain. The remaining variables that are not set by this process are determined dynamically via the human-designed transition probabilities as needed. Strategic restrictions of the stage completion rule complexity (and associated implication steps) thus aid the Markov decision process solver to infer actions that match human intuition in an acceptable convergence time.

The transition probabilities Pₐ(s,s′) is the probability that action a in state s at time t will lead to state s′ at time t+1. The transition probabilities Pₐ(s,s′) may be included with the “conditions” field and the logical expression language including implication rules. The “independent_state_settings” field is a list, more than one variable may be changed as a result of an action. This field has the name “independent” because the enumerated variables are sampled using a probabilistic independence assumption. One example in the Budget Existentials Stage 504 of the Budget Workflow 500 is as follows:

| | |
|---|---|
| - | flow_stage: budget:budget_existentials |
| | conditions: [‘is_it_classified_as_capex_budget:unknown’] |
| | action_id: 0 # ask if its capex |
| | independent_state_settings: |

| | |
|---|---|
| - | variable: is_it_classified_as_capex_budget |
| | denominator: 100 |
| | outcomes: |

| | |
|---|---|
| - | numerator: 30 |
| | setting: ‘yes' |
| - | numerator: 30 |
| | setting: ‘no’ |
| - | numerator: 30 |
| | setting: ‘idontknow’ |
| - | numerator: 10 |
| | setting: ‘unknown’ |

Another example in the Bottom Stage 602 of the Interest Workflow 600 is as follows:

| | |
|---|---|
| - | flow_stage: interest:bottom |
| | conditions: [‘progressive_company:unknown’] |
| | action_id: 46 # end users adoption patterns around new disruptive |

paradigm shifting technologies

independent_state_settings:

| | |
|---|---|
| - | variable: progressive_company |
| | denominator: 100 |
| | outcomes: |

| | |
|---|---|
| - | numerator: 49 |
| | setting: ‘yes' |
| - | numerator: 49 |
| | setting: ‘no’ |
| - | numerator: 1 |
| | setting: ‘idontknow’ |
| - | numerator: 1 |
| | setting: ‘unknown’ |

The transition probabilities Pₐ(s, s′) may be based on data probability distributions or manually prescribed.

In one embodiment, the reinforcement learning process estimates a value function Q(s,a); the expected value of taking action a at state s. In this formulation, the action with the highest value may be selected or two or more actions may be selected, such as the actions with a value over a predetermined threshold or the top two or three actions having the highest values. For example, the MDP solver determines the policy n(s) that maximizes the value V(s), and so the MDP solver can determine the state-action pair that maximizes the value V(s). This procedure, called “value iteration”, is just one possible approach to learning a policy n(s). The value V(s) may be derived from Q(s,a).

V(s)=maxₐQ(s,a)

In these neural network approaches, the states may be encoded as feature vectors rather than as distinct atomic units.

Markov Decision Processes use a discount factor to trade off the relative value of immediate versus expected future rewards. For this situation, a function is defined which corresponds to the sum of rewards:

$$Vt = Rt + γ Rt + 1 + γ 2 Rt + 2 + γ 3 Rt + 3 …$$

$$= {\sum }_{k = 0}^{∞} {γ}^{k} {R}_{t + k} = {\sum }_{Δ t = 0}^{∞} {e}^{- Δ t / τ} {R}_{t + Δ t}$$

$$wherein :$$

$$γ = e - 1 / τ$$

$$k = Δ t .$$

The variable τ explicitly shows the time horizon associated with a discount factor γ. The discount factor γ determines the value of rewards in the distant future relative to those in the immediate future. When γ=1, then the value V is equal to a sum of all the future rewards. However, future rewards may not be as certain, and so a lower discount factor γ exponentially suppresses rewards in the future. For example, for a stage 410, the discount factor γ is selected such that the time horizon includes the relevant rewards for the set of predetermined actions for that stage 410.

Rather than mapping a state to a value via the V(s) function, the Q-Learning method maps state/action pairs to values. In the eponymous Q function Q(s,a), the state and action are given as the input and the expected value for the specified action (at that state) is output. In the Deep Q-learning approach, the state s and actions are represented by a set of feature values, and the function Q is learned via a neural network. Reinforcement learning can also be used to solve Markov-Decision models without explicit specification of the transition probabilities. In reinforcement learning, instead of explicit specification of the transition probabilities, the transition probabilities are accessed through a simulator that is typically restarted many times from a random initial state.

Another, alternative manual approach is to hand-build rules in a table or database to determine the optimal action to recommend in response to a state. However, this manual approach is burdensome to create and hard to evolve. The MDP approach requires fewer manual specifications by using the algorithmic techniques to infer the optimal actions.

Example of the plurality of predefined actions for various states 410 and workflows 400 are listed in the following Table 1. In this example of Table 1, the Client's offering again includes data storage systems.

TABLE 1
A PLURALITY OF EXEMPLARY PREDETERMINED ACTIONS

| Work- | | | Action |
|---|---|---|---|
| flow | Stage | Action | Type |
| Budget | Budget | action_id: 4001 | Intervention |
| | Existentials | description: Sales representative builds monthly subscription | |
| | | pricing proposal addressed to budget owner. | |
| Budget | Budget | action_id: 8 | Information |
| | Basics | # target feature: | |
| | | budget_for_approval_cadence_achievable_steps | |
| | | description: If its budget for approval not discretionary ask what | |
| | | steps are needed for approval? | |
| Budget | Approval | action_id: 10 | Information |
| | Optics | description: Is the discretionary budget coming from the | |
| | | business unit or IT shared services? | |
| Human | Known | Pre Engagement Checklist | Offline |
| | Sales Rep | | Preparation |
| | Fit | | |
| Human | Sales Rep | action_id: 275 | Information |
| | Personal | # target feature: sales_rep_personal_inputs_defined | |
| | Inputs | # sales rep required to define platonic & intrinsic personal inputs | |
| | | description: Has sales rep defined personal inputs? | |
| Human | Unknown | action_id: 1830 | Information |
| | Personal | # target feature: | |
| | Inputs & | lead_business_unit_platonic_fit_education_influences | |
| | Implication | # lead has same educational influences | |
| | | description: Does lead have the same educational influences? | |
| Human | Personal | action_id: 1781 | Information |
| | Implications | # target feature: | |
| | Actions | lead_technical_shared_services_platonic_fit_social_network | |
| | | # lead has similar social network with sales rep | |
| | | description: does lead have similar social network with sales | |
| | | rep? | |
| Human | Unknown | action_id: 587 | Information |
| | Professional | # target feature: | |
| | Inputs & | lead_business_unit_decision_trend_storage_category_ibm | |
| | Implications | # Lead previously selected ibm. | |
| | | description: Has lead previously selected ibm? | |
| Human | Overall | action_id: 4075 | Intervention |
| | Implications | description: Sales representative to augment technical shared | |
| | | services and architecture teams domain technical deficiency with | |
| | | free technical certification training. | |
| Human | Human | action_id: 5001 | Intervention |
| | Implication | # This action is useful when the competing incumbent has better | |
| | Patterns | relationship with application team participant from joint | |
| | | attendance of database usergroup | |
| | | description: Sales representative attends and sponsors the next | |
| | | user group. | |
| Human | Human | action_id: 5026 | Intervention |
| | Implications | # This action is used when business unit lead is decision maker | |
| | Intervention | and primary driver for selection is ego | |
| | | description: Sales representative agrees for individual to speak | |
| | | at annual user conference including all travel and entertainment | |
| | | costs. | |
| Time | Yearly | action_id: 2279 | Information |
| | Structure | # target feature: enduser_project_current_calendar_year | |
| | | # end user project is for current calendar year | |
| | | description: Will end user purchase offering in the current | |
| | | calendar year? | |
| Time | Time | action_id: 2293 | Information |
| | Structure | # target feature: enduser_project_gates_production_change | |
| | | # end user frequency of making changes to production systems | |
| | | description: How frequently are changes made to production | |
| | | systems? | |
| Time | Time | action_id: 3075 | Intervention |
| | Planned | # target feature: | |
| | | enduser_planned_inputs_data_storage_cap_test_available | |
| | | description: Vendor offers additional storage resources for poc | |
| | | test. | |
| Time | Time | action_id: 2343 | Information |
| | Unplanned | # target feature: enduser_unplanned_inputs_network | |
| | | # enduser experienced unplanned network issues | |
| | | description: Has the end user experienced unplanned network | |
| | | issues? | |
| Time | Internal | action_id: 2401 | Information |
| | Time | # target feature: enduser_internal_time_variables_project_team_{—} | |
| | Variables | prioritization_application_team | |
| | | # end user experienced a time impacting change due to project | |
| | | team prioritization within application team | |
| | | description: Has end user experienced a time impacting change | |
| | | due to project team prioritization within the application team? | |
| Time | External | action_id: 2372 | Information |
| | Time | # target feature: enduser_external_time_variables_supply_chain | |
| | Variables | # end user experienced a project time impacting change due to | |
| | | supply chain | |
| | | description: Has end user experienced a time impacting change | |
| | | due to a supply chain? | |
| Time | Time | action_id: 2450 | Information |
| | Expediting | # target feature: | |
| | Factors | enduser_time_expediting_inputs_project_team_higher priortizati | |
| | | on_sourcing | |
| | | # end user experienced a time expediting event due to a higher | |
| | | prioritization within sourcing | |
| | | description: Has end user experienced a time expediting event | |
| | | due to a higher prioritization within sourcing? | |
| Time | Time | action_id: 2419 | Information |
| | Inhibiting | # target feature: | |
| | Factors | enduser_time_inhibiting_inputs_higher_labor_turnover | |
| | | # end user experienced a time inhibiting event due to higher | |
| | | labor turnover | |
| | | description: Has end user experienced a time inhibiting event | |
| | | due to higher labor turnover? | |
| Time | Historical | action_id: 2466 | Information |
| | Time Proxy | # target feature: enduser_past_projects_ownership_change | |
| | Factors | description: Did end user complete project with ownership | |
| | | change on past effort resembling proxy to current offering | |
| | | selection process? | |
| Time | Project | action_id: 2580 | Information |
| | Offering | # target feature: | |
| | Selection | enduser_project_offering_selection_enduser_offering_requisiton | |
| | | complete | |
| | | description: Has the enduser completed and submitted/approved | |
| | | requisition for vendor offering? | |
| Interest | Bottom | action_id: 4025 | Intervention |
| | | # target feature: datastorage_required_filesystem_gpfs | |
| | | description: Sales representative checks whether vendor offering | |
| | | supports the gpfs file system or not. | |
| Interest | Focus Inputs | action_id: 116 | Information |
| | | # target feature: participant_architect_referral | |
| | | # vendor was referred to architect by trusted advisor | |
| | | description: who referred you? | |
| Interest | Interaction | action_id: 5070 | Intervention |
| | Optics | # target feature: enduser_usecase_technical_requirements | |
| | | description: Given project use case does not support vendor | |
| | | offerings, functional value proposition, and sales motion ... sales | |
| | | rep will either abandon opportunity or find a different use case | |
| | | within business unit, technical shared services, application team, | |
| | | architecture, or sourcing. | |
| Interest | Post | action_id: 241 | Information |
| | Interaction | # target feature: | |
| | | lead_business_unit_project_aligns past_projects_vendor_selection_{—} | |
| | | conservative | |
| | | description: How does vendor's technology, company and | |
| | | paradigm maturity compare to other data storage vendors selected | |
| | | for similar projects led by the business unit previously? | |
| Interest | Post | action_id: 233 | Information |
| | Interaction | # target feature: | |
| | | enduser_current_project_aligns_past_projects_vendor_selection_{—} | |
| | | progressiveness | |
| | | description: How does the vendor's technology, company, and | |
| | | paradigm maturity compare to other data storage vendors selected | |
| | | for similar projects previously? | |
| Interest | Interest | action_id: 178 | Information |
| | Patterns | # target feature: | |
| | | lead_technical_shared_services_decision maker | |
| | | # technical shared services assigned project lead has authority to | |
| | | select vendor | |
| | | description: Do you have the authority to select the vendor? | |

Table 1 lists a plurality of exemplary predefined actions associated with the various stages 410 and workflows 400. Each of the plurality of predefined actions includes an action id, description, and action type. A target feature may also be associated with an action. The target feature describes one or more variables 420 in a stage 410 that are relevant to and associated with the action. The actions and the target features are customizable to a Client and to a Client's product and/or service offering as well as to the industry, type of End User, etc.

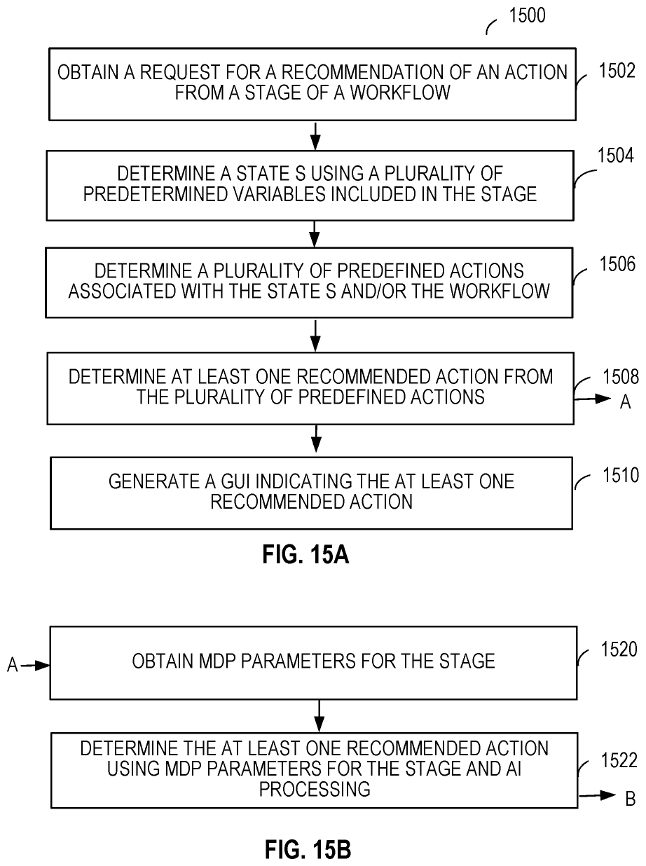

FIG. 15A illustrates a method 1500 for determining an action recommendation in accordance with one exemplary embodiment of the present invention. At 1502, a request for a recommendation of an action is obtained, e.g., such as from a browser 142 of a user device 140 over one or more networks in the computing environment 150. In another embodiment, the action recommendation is generated automatically in response, e.g., to updating one or more variables in a stage 410.

At 1504, a state s of the stage 410 is determined. The state s may be determined by comparing the current set of values of the variables in the stage 410 to the unique set of values associated with a set of predefined states. A plurality of predefined actions is then determined at 1506. A finite set of predefined actions associated with the state s and/or the stage 410 and/or the workflow 400 may be selected.

In step 1510, at least one recommended action is selected from the plurality of predefined actions. The selected recommended action is then provided to the sales representative, e.g., by generating a GUI for display on the user device 140 at 1512.

Referring to FIG. 15B, one exemplary method for determining the recommended action includes using an AI processing method and an MDP model of the state 410. The MDP parameters (S, A, P, R) for the stage 410 may be obtained from a configuration file at 1520. These MDP parameters include the finite set of predefined states S for the stage 410 and the plurality of predefined actions A associated with the initial state s or the stage 410. In addition, the MDP parameters include the probability that action a in state s at time t will lead to state s′ at time t+l and the reward R (s, s′) associated with each of the states. The at least one recommended action is then determined using the MDP parameters for the stage and AI processing, such as an MDP solver, at 1522. The purpose of the rewards is to provide domain experts the ability to shape the recommended actions of the sales system 100.

In an example, a reward r equal to −15 is assigned when either predefined action 41 or 42 is performed at a state s in the Bottom Stage 602 of the Interest Workflow 600 when solving the Markov decision process.

action_ids: [41, 42]
conditions:

| | |
|---|---|
| - | > |
| | interest_in_on_premise_datastorage:yes |
| | OR interest_in_cloud_datastorage:yes |

reward: −15
stage: bottom

So for example, when in a state s of the Bottom Stage 602 of the Interest Workflow 600, an input to the variable of “interest_in_on_premise_datastorage” equals “yes”. In this case when action 41 or 42 is selected an immediate reward of −15 will apply.

The transition probability (described above) will specify the probabilities of transitioning to a new state s′ as a result of these actions. In one embodiment, an optimal policy function π(s) and value function V(s) are determined by a neural network approach such as an Actor/Critic method. The optimal policy is used to select the one or more recommended actions. In another embodiment, the reinforcement learning process estimates a value function Q(s,a); the expected value of taking action a at state s. In this “Q-learning” formulation the action with the highest value may be selected or two or more actions may be selected, such as the actions with a value over a predetermined threshold or the top two or three actions having the highest values.

In yet another embodiment, rather than using an AI processing method, a manually constructed database, e.g., stored in a memory device 120, is used. The database includes a plurality of predetermined states s and associated one or more recommended actions from each predetermined state s. For example, for a stage 410 of a workflow 400 with a limited number of states s and a limited number of predetermined actions, a manually constructed database may be preferable. The database would then list a predetermined states s in the stage 410 and the one or more associated recommended actions a for that predetermined state s. However, this method of a manually constructed database is not optimal for stages 410 including a large number of states and/or actions or for customizing states and actions for different Clients. The AI module 1200 provides an easier method to evolve and to customize recommended actions for various stages and Workflows by specifying new goal state identification rules, reward rules, and transition probability rules. These rules are easier to construct because they do not require contemplating the complete enumeration of the state space where the action is desirable; the Markov decision process solver deduces those details. The action recommendation subsystem 306 thus provides an intelligent and customizable method for providing guidance to sales representatives.

There are certain states of a Markov decision process that are terminal, but do not indicate that the stage is complete. These states may not have an internal transition rule that applies due to lack of condition matching. These states may be designated as “dead ends” using rules like the one below.

| | |
|---|---|
| - | flow: budget |
| | stage: approval_optics |
| | conditions: [‘strategic_initiative_research_or_busdev:{no,idontknow}’] |

The conditions field uses the logical expression language to determine if the rule applies to the given state. Upon reaching a state that satisfies the given conditions, the Markov decision process terminates. In an embodiment, no particular reward is specified for this termination; it is sufficient that the process did not reap the positive rewards of stage completion. Specifying dead ends explicitly can speed up the convergence of the Markov decision process solver since it does not need to explore unfruitful directions.

Configuring the variables, transition probabilities rewards, and other components of the Markov decision process requires careful design to ensure the MDP solver infers the desired actions in a situation. Since the solvers of MDPs are iterative in nature, it is also important to ensure that the MDP solver has converged before terminating the process. The system 100 may be tested using a configuration schema of “test cases” to verify that the inferred solution of the MDP matches the desired behaviour. The configuration includes a conditions field that employs the logical expression language. The test cases are not expected to be exhaustive, as the total count of states is exponential in the number of variable configurations. As problematic behaviours are discovered, they may be added to the test cases. In the example below, the rule instructs that action 21 is the expected recommendation when the below given conditions are matched for the Approval Optics stage 508 of the Budget Workflow 500.

| | |
|---|---|
| - | flow: budget |
| | stage: approval_optics |
| | tag: one_hop |
| | conditions: [‘discretionary_and_business_unit_or_it_shared_cost:yes', |

‘strategic_initiative_research_or_busdev:yes']

actions: [21] # ask: Is this project considered a strategic initiative to build a net new

“greenfield” environment

In this manner, problems with convergence or Markov decision process design may be detected. Stage convergence tests are used to validate the learned model against human intuition; the “convergence” refers to the alignment of human intuition and the Markov decision process solution. It is a testing mechanism to verify the system aligns with desired behaviours.

Sometimes, multiple rules will match in a state s, and then the system 100 must determine which rule to apply. This pertains to the transition probabilities rules, and the rewards rules. It does not pertain to the stage satisfaction, stage convergence, or terminal state rules, for these types of rules the existence of any match rule is sufficient to give the desired behaviour of the system.

When multiple rules do match in a state s, a decision list approach for rewards and transition rules is used by the system 100. The decision lists may be learnable using an AI process or the decision lists may be created manually by listing the riles in precedence order within a configuration file. The first rule in the configuration file for which the logical expression evaluates as “True” is the rule to apply to the scenario. An alternative approach would be to use a manually constructed decision tree.

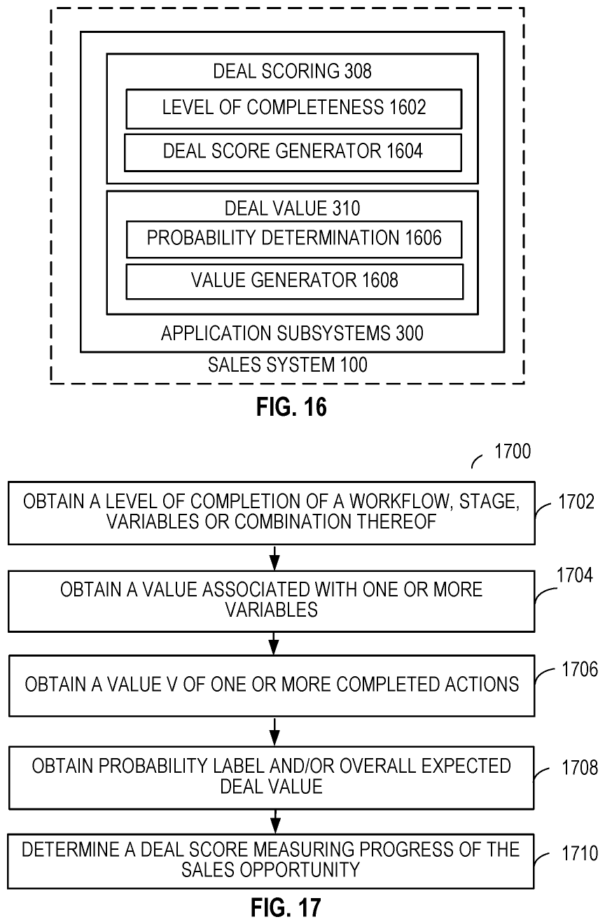

FIG. 16 illustrates an exemplary embodiment of the deal scoring sub-system 308 and the deal value sub-system 310 of the sales system 100 in accordance with one exemplary embodiment of the present invention. The deal scoring subsystem 308 generates a deal score measuring a sales representative's progress in a sales opportunity. The deal value subsystem 310 generates a present value of the sales opportunity. The two sub-systems 310, 312 may utilize similar data and processing modules, as described herein. For example, the deal scoring sub-system 308 and the deal value sub-system 310 may include separate software components and/or include software components included in one or more of the sub-systems and stored in the server memory device 116, wherein the software components include instructions which when performed by the application server 110 perform one or more of the functions described herein.

The level of completeness is determined, e.g., by a level of completeness (LOC) module 1602, for the workflows 400 or the states 410 or the individual variables 420 in the states 410 or a combination of one or more of these. The deal score generator 1604 determines the deal score using the level of completeness of one or more of the workflows 400 or the states 410 or the individual variables 420 in the states 410 or a combination of one or more of these. The level of completeness may be presented as a percentage, a relative level (e.g., none, low, mid, high complete), a numerical value, a fraction, or other measure. The deal score may be a sum, a mean, or an average of the level of completeness score of one or more of the workflows 400, one or more of the stages 410 and/or one or more of the variables 420.

In another embodiment, the overall deal score may also be a function of individual Workflow features (e.g., variables 420 with entered values 430). For example, the deal score generator 1604 may use the variable values for implication rules such as the “platonic_fit” variable indicating the degree of progress and fit in the Human Workflow 800 described with respect to FIG. 8. The values for other individual variables may also be used in the deal scoring.

In another embodiment, the value V of the current state or the value Q of the recommended actions taken by the sales representative may be considered when determining the deal score. This input would motivate a sales representative to perform the recommended actions because the sales representative would directly see a correlation between completing a recommended action and the deal score.

The GUI subsystem 302 generates one or more GUIs indicating the points earned by the sales representative and an overall deal score (and/or level of completeness) of individual Workflows 400 by translating the scores into colors. For example, the colors green/yellow/red may indicate a level of completeness or deal score for each workflow 400, wherein green=complete, yellow=in progress, and red=suboptimal, incomplete, or not started. The numerical score (e.g., in a range from 1-100) or percentage of the deal score may also be displayed in one or more GUIs. The sales representative earns points by completing the stages and Workflows and so increases their overall deal score. The sales system 100 generates the earned points and overall deal score as motivation to the sales representative. The sales opportunity may be viewed as a “Game” to be completed by the sales representative.

The deal value subsystem 310 focuses on the expected monetary value and probability of the sales opportunity for planning and revenue forecasting by the Client. The probability determination module 1606 associates a probability label with one or more states of one or more stages or Workflows. The probability label represents the probability of deal success at a given state. Using this probability of deal success, the Value Generator module 1608 determines an overall expected deal value by multiplying this deal success probability by the offering value, wherein the offering value is the Client's offered value for the sales opportunity.

The probability labels may be manually determined, such as by one or more experts in the field of sales. For example, a state of one or more of the Workflows is provided to the one or more experts to provide a probability of success of the sales opportunity. The probability labels may also be statistically determined, determined by training a model, and/or adjusted over time using the experiences of different Clients. The probability labels may also be customized for different industries, products, services, Clients, End Users, etc.

In another embodiment, the probability labels are determined using a learning-to-rank paradigm, such as a LambdaRank model. The one or more experts are provided a pair of two states of a Workflow 400 or a stage 410 from a set of states. The experts rank one state of the pair as having a relatively higher probability of success than the other state in the pair. This ranking process is iteratively repeated by the experts between different pairs of states until a ranking of the states in the set of states is determined, e.g., from most likely to succeed to least likely to succeed. This approach has the advantage of not requiring the one or more experts to apply calibrated probability estimates to the states. The learning-to-rank models, such as LambdaRank, do not output probabilities, but the ranking of the states may be translated into output scores in a 0-1 range using transforms such as a logistic transform. In another embodiment, the experts may perform exemplary rankings to train an AI LambdaRank model.

In an embodiment, the 0-1 range score is transformed into a probability by constructing a rank-to-probability model. For example, a logistic regression model may be determined based on the ranks. Alternatively, a 1-dimensional k-means clustering on the ranks is performed and probabilities are manually selected for each bucket. The training set rank values may be employed in future scenarios by translating the output score into an interpolated rank (as determined by the training set), and feed that interpolated rank into the rank-to-probability model. With these approaches, the benefits of a pairwise label task and a probability estimate of success are both incorporated into determining the probability of success of a sales opportunity.

In an embodiment, the overall expected deal value and/or the probability of success may also be used in the deal score. For example, as the probability of success of the sales opportunity increases, the deal score may also increase.

FIG. 17 illustrates a method 1700 for determining a deal score in accordance with one exemplary embodiment of the present invention. The deal score is determined using one or more factors described with respect to this FIG. 17. At 1702, a level of completion is obtained for one or more of: the plurality of Workflows 400; the plurality of stages 410 in one or more of the Workflows 400, or the plurality of variables (or features) in one or more stages 420 of one or more Workflows 400. For example, when a workflow 400 is complete, obtaining a level of completion of the individual stages of the Workflow 400 is not needed. In another example, the Client may indicate that one or more stages 410 or Workflows 400 are not needed for a sales opportunity. The sales system 100 may then exclude those indicated stages 410 or Workflows 400 from the deal scoring. A sales representative will thus be presented with a more accurate progress of the deal from the deal score.

At 1706, values associated with one or more variables may be obtained. For example, using implication rules, an ordinal value is assigned to one or more variables in the Human Workflow 800, as described with respect to FIG. 8. These ordinal values associated with one or more variables may be used when determining the deal score. Additionally or alternatively, the action distribution vector n(s) associated with one or more recommended actions may be obtained. For example, the sales system 100 in response to a state s of a Workflow 400 may recommend an action based on its value π(s), as described above. If the recommended action is completed, the value V of the new state s′ may be stored and used in determination of the deal score. In addition, the overall expected deal value and/or the probability of deal success at the time may be obtained and used in determination of the deal score at 1708.

Using one or more of these described factors, the deal score is determined at 1710. Additional or alternate factors may also be used in the determination of the deal score. The deal score provides a sales representative and managers a measure of progress in the sales opportunity.

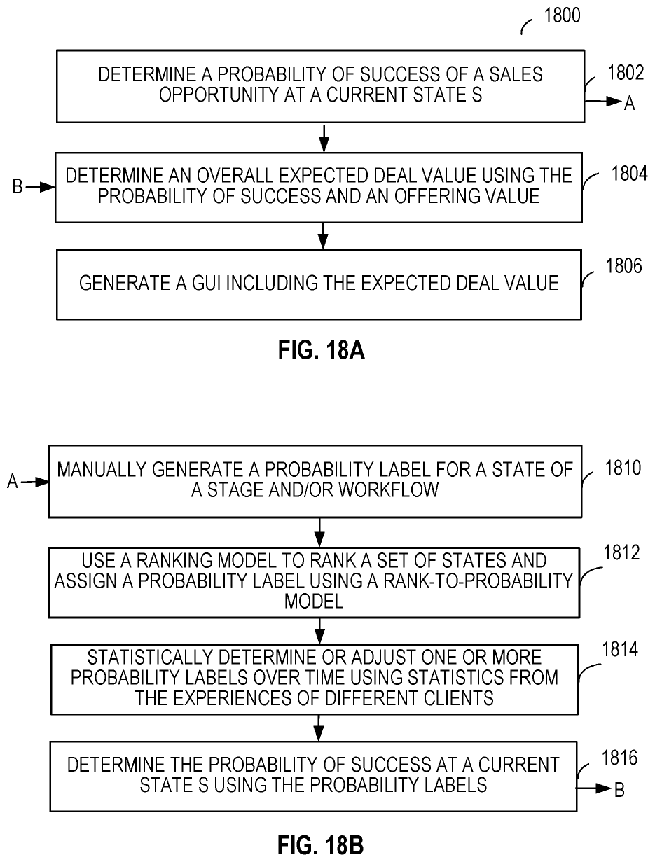

FIG. 18A illustrates a method 1800 for determining an overall expected deal value in accordance with one exemplary embodiment of the present invention. At 1802, a probability of success of a sales opportunity at a current state is determined, as described in more detail with respect to FIG. 18B. The current state means the current values 430 of the variables 420 of the stages 410 in the Workflows 400 for the sales opportunity. The offering value of the sales opportunity is also obtained. This offering value is determined from one or more variables in the Budget Workflow 500 and is input by the Client. The expected deal value is then determined using the probability of success and the offering value at 1804. For example, the offering value is multiplied by the probability of success to determine the expected deal value. The expected deal value is then included in one or more GUIs, e.g., generated by the GUI subsystem 302, relating to the sales opportunity.

FIG. 18B illustrates a method for a probability of success of a sales opportunity at a current state in accordance with one exemplary embodiment of the present invention. The probability labels may be determined using one or more of the methods described herein. For example, at 1810, one or more probability labels are manually determined by one or more experts in the relevant field of sales. For example, the one or more experts review a state, wherein the state is defined by the value of variables in a certain stage or in the entire Workflow or the values of the variables in all the stages of all the Workflows). The one or more experts then estimate a probability of success of the sales opportunity in that defined state.

In another embodiment, at 1812, the one or more experts rank a set of states on their relative probability of success, e.g. using a LambdaRank method or other ranking method. The ranking of the states may then be mapped into probabilities of success (e.g., a in a 0-1 range), using a rank-to-probability model. The rank-to-probability model may use a logistic transform or a logistic regression model or a 1-dimensional k-means clustering on the ranks. The rankings of the set of states are then translated to probability labels for each state in the set.

At 1814, the probability labels may also be statistically determined or adjusted over time using data collected from the Client or of a plurality of clients with similar fields or product offerings. The sales system 100 stores different states and the eventual outcome of the sales opportunity. The sales system 100 may then generate a statistical map of states and probability of success of the sales opportunity. Since this statistical method based on Clients experiences may require months or years of data, the probability labels may be generated manually using the one or more experts, as described above at 1810 or 1812. Then the probability labels may be updated using statistical data over time. The statistical data may also be used to determine the states and variables that are more important to the probability of success. This information may help determine recommended actions from a state or new actions for implementation.

The probability of success at a current state s is then determined using the probability labels at 1816. When a probability label has not been assigned to the current state s, similar states may be determined and the probability labels for the similar states may be used. For example, an average or mean of the probability labels for the similar states may be determined and assigned to the current state s. The probability of success is then equated to or derived from the probability label of the current state s.

The probability labels and/or statistical data of an End User may also be used to provide customized Workflows 400, states 410 and recommended actions 420. The sales system 100 may track the recommended actions performed by sales representatives of an End User in practice to progress sales opportunities to completion. This data is used to revise the Workflows 400, states 410 and/or recommended actions 420 for that End User. In one embodiment, a manual analysis of the past recommended actions and outcomes is performed, and determinations are manually made on the revisions to the Workflows 400, states 410 and/or recommended actions 420. In another embodiment, automated analysis by the sales system 100 generates data of one or more End Users. The AI module 1200 then performs one or more of inverse reinforcement learning, imitation learning, apprenticeship learning or other learning processes on the data. Using these processes, the AI module 1200 then generates recommendations on revisions to the Workflows 400, states 410 and/or recommended actions 420 for the one or more End Users.

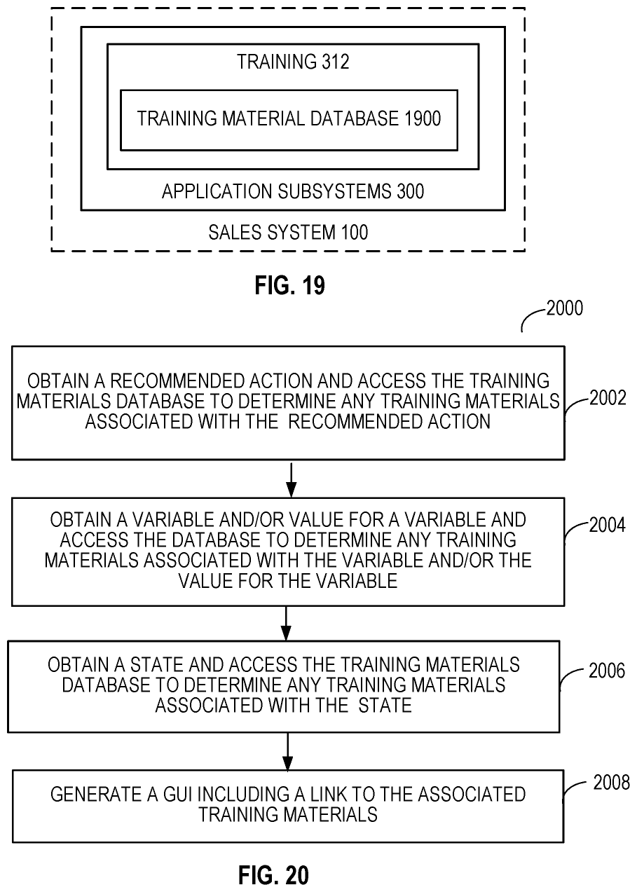

FIG. 19 illustrates an exemplary embodiment of the training sub-system 312 of the sales system 100 in accordance with one exemplary embodiment of the present invention. The training sub-system 312 includes a training material database stored in a memory device, such as server memory device 116 or external memory device 120. The database 1900 includes a listing of training materials and any associated variables, values of variables, states and/or actions. The listing of the training materials may include an identification of the training materials and links to the training materials. The training materials may include one or more of: video files, audio files or data files.

FIG. 20 illustrates a method 2000 for providing training materials in the sales system 100 in accordance with one exemplary embodiment of the present invention. At 2002, an identification of a recommended action (such as an action id in Table 1) is obtained by the training subsystem 312, e.g., through a message from the action recommendation subsystem 306 or GUI subsystem 302. The training subsystem 312 accesses the training material database 1900 and identifies any training materials associated with the recommended action. A link to the associated training materials is then provided for display on a GUI with the recommended action at 2008. Thus, when a recommended action is generated, an icon with a link to or a window with the associated training materials are displayed in the GUI with the recommended action. The training materials may explain the rationale and strategy behind the recommended action so that a sales representative understands the recommended action and may become more proficient. Alternatively, and/or additionally, the associated training materials may explain how to perform the recommended action, such as how to prepare an RFP or budget proposal.

The training subsystem 312 may also provide training materials associated with a variable or value of a variable. In an embodiment, when a variable is selected or displayed, at 2004, an identification of the variable or value of the variable is obtained by the training subsystem 312, e.g., through a message from the deal progression subsystem 304 or the GUI subsystem 302. The training subsystem 312 accesses the training material database 1900 and identifies any training materials associated with the variable or the value of a variable. When associated training materials are identified, the icon with a link to or a window with the associated training materials are displayed in the GUI with variable or the value of the variable. For example, when a variable relating to “Operating Expense” or “Capital Expenditure” is selected in the Budget Workflow 500, an icon with a link to or a window with the associated training materials are displayed in the GUI at 2008. The training material may define the two terms and explain the appropriate steps and strategies of each in a sales opportunity. In another example, when an “idontknow” value is entered for a variable, the associated training material with this value of the variable may be displayed that explains the variable and suggestions on how to obtain the information.

The training subsystem 312 may also provide training materials associated with a state of a stage 410 or a Workflow 400 at 2006. In an embodiment, a predefined state of a stage 410 or workflow 400 is obtained. The state may be predefined by the values of one or more variables in the stage or workflow. The training subsystem 312 accesses the training material database 1900 and identifies any training materials associated with the predefined state. When associated training materials are identified, the icon with a link to or a window with the associated training materials are displayed in the GUI with the associated stage 410 or Workflow 400. For example, a stage 400 of a Workflow 410 may have no input values 430 to the variables 420 in the stage 400. This predefined state may be associated with training materials that suggest how to begin gathering information for the stage 410.

The training subsystem 312 may also provide training materials associated with topics or questions. For example, a HELP icon may be displayed in one or more GUIs. A question or topic may be received that is input into the HELP section of the GUI. The training subsystem 312 accesses the training material database 1900 and identifies any training materials associated with the topic of the question. When associated training materials are identified, the icon with a link to or a window with the associated training materials are displayed in the GUI with HELP section.

The training subsystem 312 thus proactively provides training materials in response to a recommended action, a variable or selection of a value for a variable, or a state of a Stage 410 or Workflow 400. The training materials thus help to coach the sales representative through the progression of a sales opportunity.

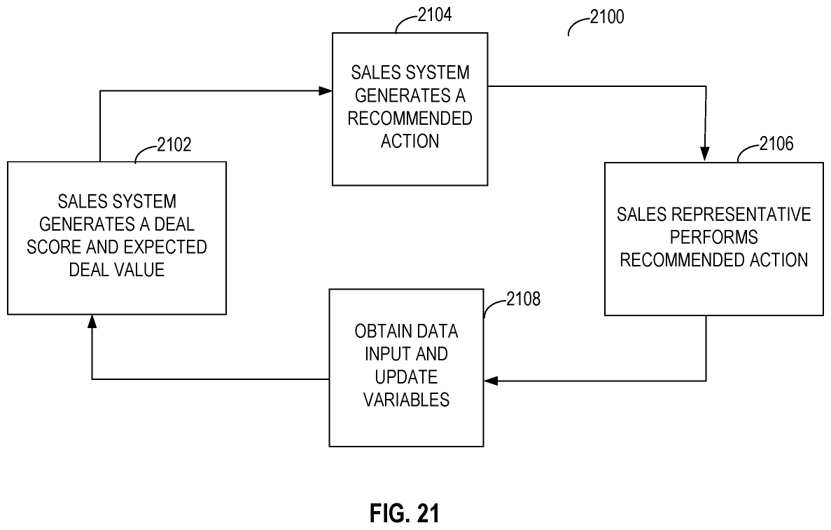

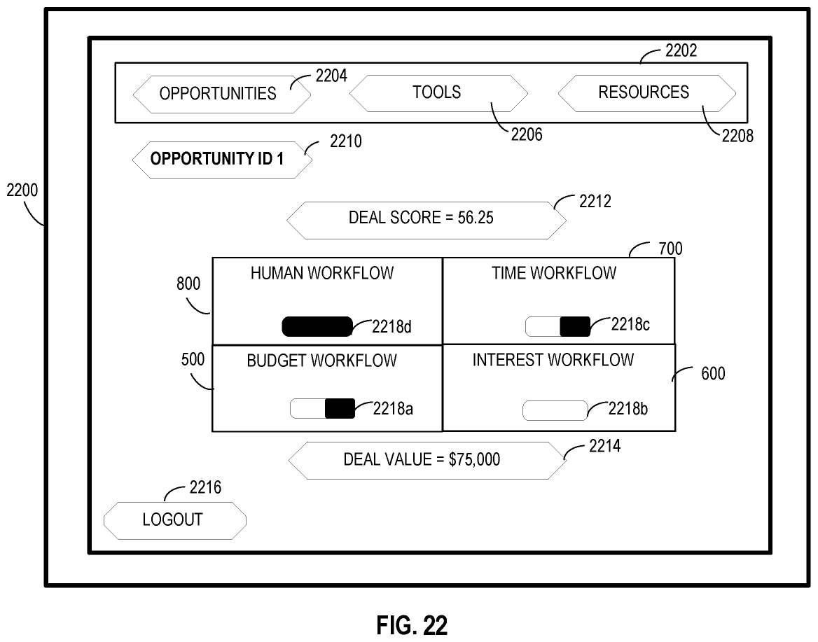

FIG. 21 illustrates a method 2100 of operation of the sales system 100 according to one exemplary embodiment of the present invention. At 2102, the sales system generates a deal score and expected deal value. Based on the level of completion of one or more Workflows 300, the software provides a recommended action at 2104. A sales representative then performs the recommended action at 2106. At 2108, the sales representative inputs data, and the sales system 100 updates the values of one or more variables. The sales system 100 then updates the deal score and expected deal value. This cycle continues until the sales opportunity is completed, or the sales opportunity is abandoned. A sales representative may thus follow these steps to progress the sales opportunity. The following FIGS. 22-26 include exemplary GUIs generated by the sales system 100 illustrating this cycle.

FIG. 22 illustrates a graphical user interface (GUI) 2200 of a sales opportunity of the sales system 100 according to one exemplary embodiment of the present invention. The GUI 2200 may be generated by the GUI subsystem 302 and may be displayed by a browser 142 operating on a user device 140. The GUI 2200 includes a navigation bar 2202 that includes an opportunities menu 2204, a tools menu 2206, and a resources menu 2208. For example, upon selection of the opportunities menu 2204, one or more sales opportunities names and/or ids are displayed and may be selected. In this exemplary GUI 2200, a sales opportunity 2210 with an opportunity id=1 has been selected from the opportunities menu 2204.

In response to the selection, the GUI 2200 displays various information related to the selected sales opportunity 2210. For example, the deal score 2212 and expected deal value 2214 for the selected sales opportunity 2210 are displayed. The one or more workflows 400 for the selected sales opportunity 2210 are also displayed. In this example, the one or more workflows 400 include the Budget Workflow 500, Interest Workflow 600, Time Workflow 700, and Human Workflow 800.

In an embodiment, the workflows 400 may have an indication of a level of completion. For example, one or more colors may indicate the level of completion for each workflow 400, e.g., green=complete, yellow=in progress, and red=not started. A numerical score (e.g., in a range from 1-100) or percentage of the deal score may alternatively be displayed to indicate the level of completion. In this example, level icons 2218a-d indicate a level of completion of the workflows 400. The level icon 2218b for the Interest Workflow 600 indicates that no data has been entered in that workflow while the level icon 2218d for the Human Workflow 800 indicates that the workflow is complete. The level icons 2218a, 2218c for the Budget Workflow 500 and the Time Workflow 700 indicate that the workflows are partially complete.

The GUI 2200 may further include a logout icon 2216. When selected, a logout procedure is initiated to logout the sales representative from the sales system 100 and prevent further access to the sales system 100 on the user device 140. To access the sales system 100 again, a login procedure requiring a password and/or another authentication is then required.

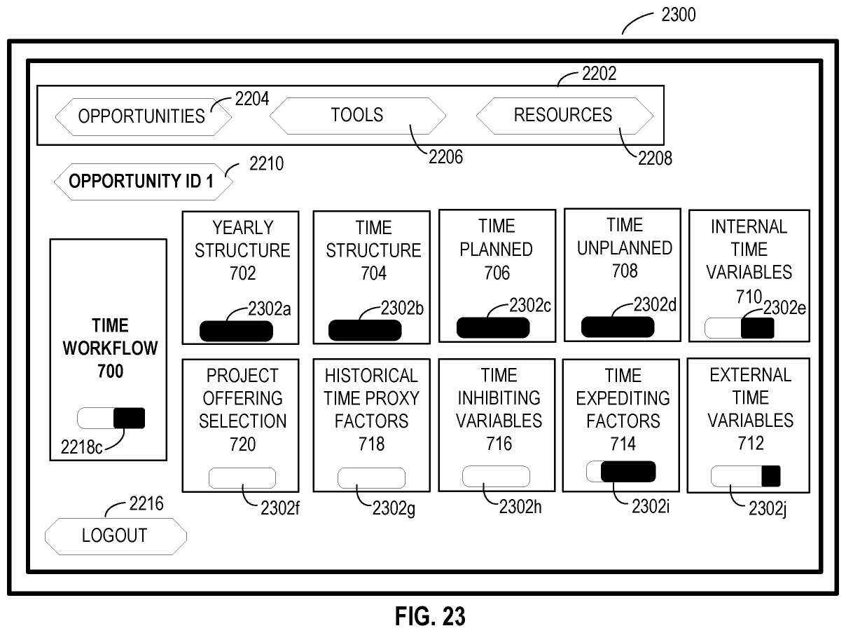

FIG. 23 illustrates a GUI 2300 of the Time Workflow 700 in the sales system 100 according to one exemplary embodiment of the present invention. This GUI 2300 includes the time workflow 700 from FIG. 22. Upon selection of the time workflow 700 icon in FIG. 22, the GUI subsystem 302 generates this exemplary GUI 2300 showing the plurality of stages 410 in the time workflow 700. The plurality of stages 410 each include a level indicator 2302a-j. The level indicator 2302a-j for each stage 400 indicates a level of completion for that stage 400.

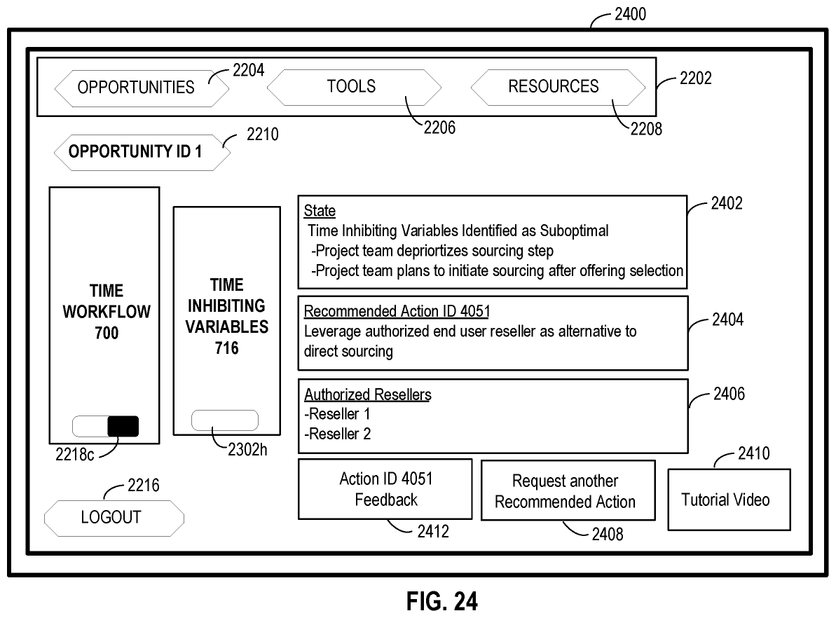

FIG. 24 illustrates a GUI 2400 of a stage 716 of the Time Workflow 700 in the sales system 100 according to one exemplary embodiment of the present invention. This GUI 2400 includes the time inhibiting variables stage 716 from FIG. 23. Upon selection of the time inhibiting variables stage 716 icon in FIG. 23, the GUI subsystem 302 generates this exemplary GUI 2400 showing the current state 2402 of the plurality of stage 716. The level indicator 2302h for the time inhibiting variables stage 716 indicates that the stage 716 has not been started, e.g., no values have been entered for the one or more variables of the stage 716. The sales system 100 may receive data input into one or more variables in the stage 716 from the sales representative that indicates a state 2402. As shown in GUI 2400, the state 2402 is described as, “Time Inhibiting Variables Identified as Suboptimal”. For example, data (e.g., entered by the sales representative in response to one or more variables) indicates that the project team of the potential End User has deprioritized the sourcing step of the client or the project team plans to initiate sourcing after offering selection.

The sales system 100 in response to the data input in state 2402 generates a recommended action 2404. The recommended action 2404 states, “Leverage authorized end user reseller as alternative to direct sourcing.” The authorized end user resellers 2406 may also be displayed with the recommended action 2404. For example, the recommended action 2404 may explain that the sales representative should persuade the project lead of the potential End User to allow receipt of authorized resellers' proposals as an option instead of the direct sourcing relationship between the vendor and End User. The GUI 2400 further includes an Action Feedback icon 2412 to provide feedback on the recommended action. The sales representative may provide feedback on the usefulness of that action and ways that the recommended action can be improved. The sales system 100 may thus learn and improve on recommended actions using the feedback.

The GUI 2400 may also include a request for another recommended action 2408 or an icon to a link to request another recommended action 2408. For example, the sales representative may in their own judgement determine to override or ignore the first recommended action 2408 and request another suggestion that may be more appropriate to optimize the state of the sales opportunity. The sales representative may then proceed to follow the one or more recommended actions, or the sales representative may determine to override the recommended actions and perform other actions.

The GUI 2400 further includes a training materials icon 2410 with a link to a tutorial video. For example, in response to the recommended action 2404, the training subsystem 312 proactively, without selection or further input from the sales representative, determines that training materials are associated with the recommended action 2404. The training materials icon 2410 with a link to the associated training materials is then displayed in the GUI 2400 with the recommended action 2404. In this example, the training materials include a tutorial video, though the training materials may also include audio files or data files. In addition, in this GUI 2400, a link to the associated training materials is presented but the training materials may be presented in a pop-up window. For example, the pop-up window may include a link to the training materials or may present brief suggestions, advice, or helpful explanations.

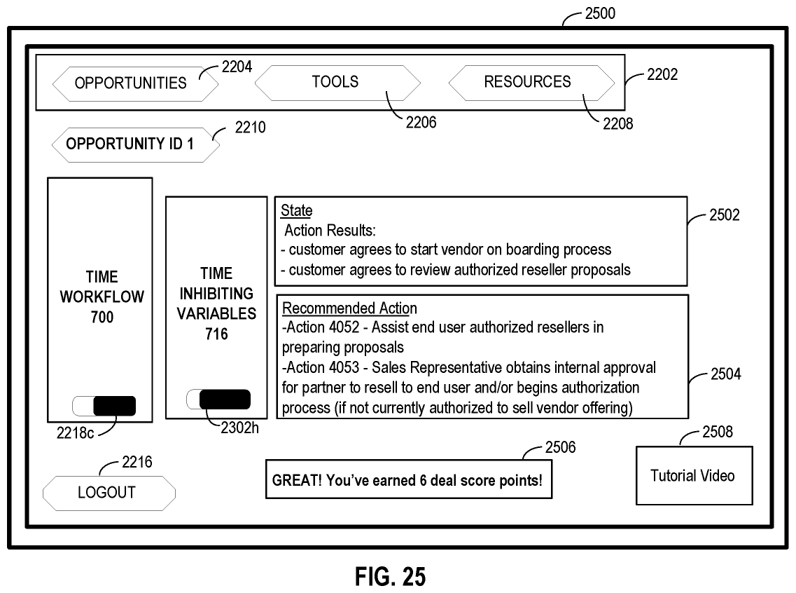

FIG. 25 illustrates another GUI 2500 of the time inhibiting variables stage 716 of the time workflow 700 in the sales system 100 according to one exemplary embodiment of the present invention. This exemplary GUI 2500 includes a new State 2502 with action results entered by a sales representative after performing the recommended action 2404 from FIG. 24. The action results may be entered as values to one or more variables. For example, a variable may include “End User start vendor on boarding” and the value entered is “yes.” In another example, a variable may include, “End User review authorized reseller proposal” and the value entered is “yes.”

The GUI 2500 may also include one or more new recommended actions 2504. For example, the sales system 100 in response to the new state 2502 generates two new recommended actions 2504. The first new recommended action 2504 states, “Action 4052—Assist end user authorized resellers in preparing proposals.” The recommended action 2504 may explain that the sales representative should assist the authorized resellers in preparing the proposals for the potential end user. The second new recommended action 2504 states, “Action 4053—Sales Representative obtains internal approval for partner to resell to end user and/or begins authorization process (if not currently authorized to sell vendor offering).”

Due to the input of data, the level of completion of this stage 716 has increased with respect to FIG. 24. The level indicator 2302h now indicates that the stage 716 is closer to completion. In addition, the level indicator 2218c for the Time Workflow 700 indicates that the Time Workflow 700 is more complete.

The deal score 2212 may have increased for the sales opportunity 2210 as well due to the increased level of completion of the stage 716 and the Time Workflow 700. For example, when the one or more variables are completed by the sales representative in the stage 716, the deal scoring subsystem 308 obtains a new level of completion for the stage 716 and for the Time Workflow 700. The deal scoring subsystem 308 updates the deal score 2212 for the sales opportunity 2210 and provides the number of deal score points 2506 earned by the sales representative. The number of deal score points 2506 is then included in the GUI 2500 by the GUI subsystem 302. The sales system 100 thus presents the earned points for completing actions and presents the new deal score as progress is made, e.g., like playing a game.

The GUI 2500 further includes an updated training materials icon 2508 with a link to a reseller proposal tutorial video. In an exemplary embodiment, in response to one or more of the input of the action results and/or the new state 2502 and/or the new recommended action 2504, the training subsystem 312 proactively, without selection or further input from the sales representative, accesses the training materials database 1900 and determines that training materials are associated with one or more of the action results and/or the new state 2502 and/or the new recommended action 2504. The training materials icon 2508 with a link to the associated training materials is then displayed in the GUI 2500 with the action results 2502. In this example, the training materials include a tutorial to assist the sales representative in preparing the authorized reseller proposals.

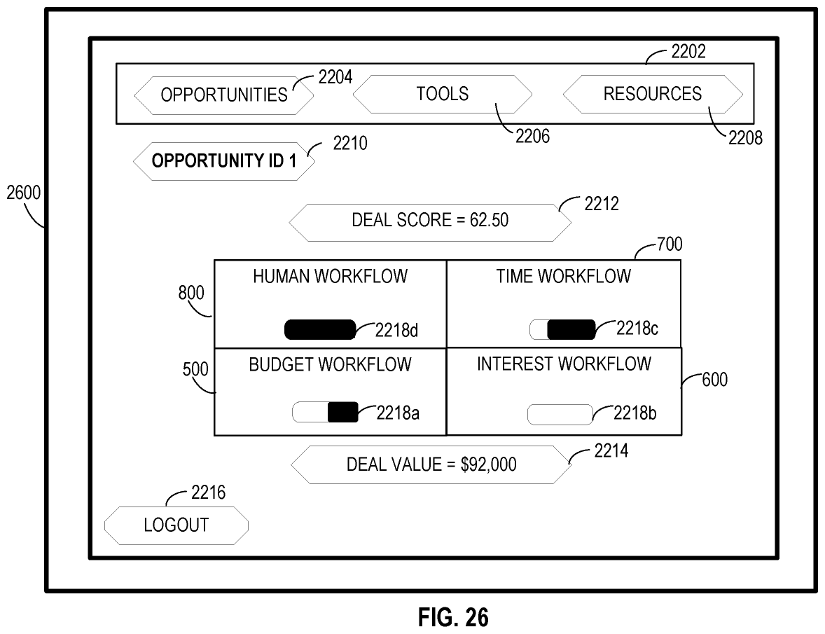

FIG. 26 illustrates an updated graphical user interface (GUI) 2600 of the sales system 100 according to one exemplary embodiment of the present invention. This GUI 2600 shows the update to the GUI of FIG. 22 in response to the completion of stage 716 of the Time Workflow 700. The GUI 2600 includes an updated deal score 2212 from that shown in FIG. 22 with 6 points added that were earned by the sales representative by completing stage 716. The level indicator 2218c for the Time Workflow 700 is again displayed indicating that the Time Workflow 700 is more complete from FIG. 22.

In addition, the GUI 2500 displays a new deal value 2214 that has increased from FIG. 22. The action results (e.g., values entered for the one or more variables) in the stage 716 indicated positive progress, e.g., a review of an authorized reseller's proposal. As such, the likelihood of success of the sales opportunity has increased. For example, the probability label of the state 2502 in FIG. 25 indicates a higher probability of success than the probability label of the state 2402 in FIG. 24. The expected deal value 2214 displayed in FIG. 26 is thus increased over the deal value 2214 in FIG. 22.

The sales system 100 improves a likelihood of success of a sales opportunity and improves job performances of sales representatives. Using AI techniques, the sales system 100 determines and recommends actions that are most optimal in a current state of the sales opportunity. Deal score points are awarded by the sales system 100 when recommended actions are performed or when stages 400 are completed by a sales representative in the sales system 100. The sales system 100 updates the overall deal score of a sales opportunity to help with motivation and measure progress. The sales system 100 decomposes a sales opportunity into manageable workflows 400 and stages 410 and incorporates “irrational” factors in a sales opportunity into the workflows. Training materials are automatically presented to a sales representative in response to the recommended actions and/or the current state of the sales opportunity. The training materials thus provide timely and relevant explanations, advice, and strategy to the sales representative. The sales system 100 also measures the likelihood of success of a sales opportunity throughout its progress and generates an expected deal value in view of the current state of the sales opportunity. These advantages are not exclusive, and more advantages may be evident from practical implementations and uses of the sales system 100.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A sales system, comprising:
at least one memory device; and
at least one processing circuit, wherein the processing circuit is operatively coupled to the at least one memory device and wherein the at least one memory device stores instructions that, when executed by the at least one processing circuit, cause the sales system to:
determine a state of a sales opportunity from a plurality of predefined states;
determine a recommended action using the state of the sales opportunity, wherein the recommended action is one of a plurality of predefined actions; and
generate a graphical user interface (GUI) for display including the recommended action.

2. The sales system of claim 1, wherein the sales system is further caused to:
generate at least one stage of a sales opportunity, wherein the at least one stage includes a plurality of predetermined variables.

3. The sales system of claim 2, wherein the sales system is further caused to:
determine the state of the sales opportunity using the plurality of predetermined variables, wherein each of the plurality of predefined states are states in a Markov Decision Process (MDP) model that are defined by a unique set of configurations for the plurality of predetermined variables.

4. The sales system of claim 3, wherein the plurality of predefined actions is associated with the at least one stage.

5. The sales system of claim 4, wherein the sales system is further caused to:
determine the recommended action using parameters of the MDP model for the at least one stage, wherein the parameters include the plurality of predefined actions, the plurality of predefined states, a reward associated with each of the plurality of predefined states, and one or more transition probabilities associated with each of the plurality of predefined states.

6. The sales system of claim 5, wherein the sales system is further caused to:
define one or more transitions from a first configuration of the plurality of predetermined variables to a second configuration of the plurality of predetermined variables; and
define an associated transition probability to each of the one or more transitions from the first configuration to the second configuration.

7. The sales system of claim 6, wherein the sales system is further caused to:
determine a set of stage satisfying variables using a set of logical expressions, wherein the plurality of predefined variables evaluate to “True” for the set of stage satisfying variables; and
determine the plurality of predetermined variables by sampling from the set of stage satisfying variables.

8. The sales system of claim 6, wherein the sales system is further caused to:
constrain logical implication rules and stage satisfaction rules to provide a polynomial time algorithm for sampling from the set of stage satisfying variables.

9. The sales system of claim 6 wherein the sales system is further caused to:
apply a specified reward value, wherein the specified reward value is determined using a current state, a new state after transition, and an action that was taken.

10. The sales system of claim 5, wherein the sales system determines the recommended action using parameters of the MDP model for the at least one stage by:
inferring an optimal policy π for each of a plurality of actions, wherein the policy maximizes the expected reward V for each of the plurality of states;
selecting the recommended action from the plurality of predefined actions using the policy X.

11. The sales system of claim 10, wherein the sales system determines a degree of completion of a state or a stage of a workflow by calculating a Markov Decision Process value function V(s) to determine a value V and comparing that value V to a predetermined reward for completing the state or the stage.

12. The sales system of claim 10, wherein the sales system determines the value V and policy π for each of the plurality of predefined states by using a reinforcement learning process.

13. The sales system of claim 5, wherein the sales system determines a value Q for each of the plurality of states by using a reinforcement learning process.

14. The sales system of claim 2, wherein the sales system is further caused to:
access a training materials database, wherein the training materials database includes a listing of training materials associated with one or more of the predefined actions from the plurality of predefined actions.

15. The sales system of claim 14, wherein the sales system is further caused to:
determine training materials associated with the recommended action; and
generate a GUI for display including the recommended action and the training materials associated with the recommended action.

16. The sales system of claim 1, wherein the sales system is further caused to:
generate a GUI for display of a deal score, wherein the deal score is presented as if progress in a game.

17. A sales system, comprising:
at least one memory device; and
at least one processing circuit, wherein the processing circuit is operatively coupled to the at least one memory device and wherein the at least one memory device stores instructions that, when executed by the at least one processing circuit, cause the sales system to:
determine a current state of a sales opportunity from a plurality of predefined states;
determine a probability of success of the sales opportunity associated with the current state;
determine an expected deal value using the probability of success and an offering value; and
generate a graphical user interface (GUI) for display including the expected deal value.

18. The sales system of claim 17, wherein the sales system determines the probability of success of the sales opportunity associated with the current state by:
assigning a rank to each of the states in the plurality of predefined states; and
determining a probability of success associated with the rank of the each of the states in the plurality of predefined states using a rank-to-probability mapping.

19. The sales system of claim 18, wherein the sales system is further caused to:
determine a rank-to-probability mapping using one or more of: a logistic transform, a logistic regression model, or a 1-dimensional k-means clustering model.

20. The sales system of claim 17, wherein the sales system is further caused to:
determine a deal score using at least a level of completeness of one or more workflows, wherein the sales opportunity is defined as a plurality of workflows.

21. A sales system, comprising:
at least one memory device; and
at least one processing circuit, wherein the processing circuit is operatively coupled to the at least one memory device and wherein the at least one memory device stores instructions that, when executed by the at least one processing circuit, cause the sales system to:
generate at least one stage for at least one workflow of a sales opportunity, wherein the at least one stages includes a plurality of variables;
determine whether a stage satisfaction rule is satisfied using a set of values for the plurality of variables;
when the stage satisfaction rule is satisfied, generate an indication of completion of the at least one stage; and
when the stage satisfaction rule is not satisfied, determine a level of completion of the at least one stage using the set of values for the plurality of variables.

22. The sales system of claim 21, wherein each of the plurality of variables of the at least one stage includes an objective attribute, wherein each of the objective attributes logically infer one of: a rational factor or an irrational factor of the sales opportunity.

23. The sales system of claim 21, wherein each of the plurality of variables of the at least one stage includes an objective attribute, wherein each of the objective attributes logically infer one of: a progressiveness of a client or a conservativeness of a client.

24. The sales system of claim 21, wherein the sales system determines whether a stage satisfaction rule is satisfied using a logical expression.

25. The sales system of claim 24, wherein the sales system determines whether a stage satisfaction rule is satisfied by:
assigning a value to each of a plurality of sets of the plurality of variables by expressing cardinal values into ordinal values; and
performing one or more aggregation functions on the values for the plurality of sets of the plurality of variables and determining a function output.

26. The sales system of claim 25, wherein the sales system determines whether the stage satisfaction rule is satisfied by:
comparing a minimum threshold to the function output, wherein the minimum threshold determines whether an irrational factor or a rational factor may be logically inferred from the objective attributes.

27. The sales system of claim 21, wherein the sales system is further caused to:
determine a deal score measuring a progress of the sales opportunity using the level of completion of the stage.

28. The sales system of claim 21, wherein the sales system is further caused to:
when the stage satisfaction rule is not satisfied, determine at least one variable having a suboptimal value;
access a training materials database, wherein the training materials database includes a listing of training materials associated with the plurality of variables of the stage;
determine a listing of training materials associated with the at least one variable having an unknown value; and
generate a GUI for display including the at least one variable having an unknown value and a link to the training materials associated with the at least one variable having an unknown value.

29. The sales system of claim 21, wherein the stage satisfaction rule comprises a sequence of function applications, wherein a last function application in the sequence of function applications is a logical expression evaluating to True or False.

30. A sales system, comprising:
at least one memory device; and
at least one processing circuit, wherein the processing circuit is operatively coupled to the at least one memory device and wherein the at least one memory device stores instructions that, when executed by the at least one processing circuit, cause the sales system to:
determine a level of completion of a sales opportunity in a plurality of workflows, wherein the level of completion is determined by a plurality of variables in a workflow and set of values associated with the plurality of variables;
determine using the level of completion of the plurality of workflows one or more of: deal score, deal completion probability, or expected deal value; and
identify one or more workflows of the plurality of workflows requiring a higher level of completion to improve one or more of: the deal score, the deal completion probability, or the expected deal value.

31. The sales system of claim 30, wherein the plurality of workflows includes at least two or more of: budget, time, interest, and human.
